(19) United States
(12) Patent Application Publication
(10) Pub. No.: US 2025/0372308 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventors: Jun KURITANI, Nagaokakyo-shi (JP); Yukie WATANABE, Nagaokakyo-shi (JP)

(21) Appl. No.: 19/058,277

(22) Filed: Feb. 20, 2025

(30) Foreign Application Priority Data
May 30, 2024 (JP) 2024-087871

(51) Int. Cl. H01G 4/30; H01G 4/012; H01G 4/232

(52) U.S. Cl. CPC H01G 4/30; H01G 4/012; H01G 4/232

(57) ABSTRACT

A multilayer ceramic capacitor includes a multilayer body including first and second surfaces facing each other in a lamination direction, third and fourth surfaces facing each other in a first direction, and fifth and sixth surfaces facing each other in a second direction, and four outer electrodes on the multilayer body. About 0.85≤L/W≤ about 1.00 is satisfied. The multilayer body includes a first inner electrode including an end exposed on the third and fifth surfaces and another end exposed on the fourth and sixth surfaces, a second inner electrode including one end exposed on the third and sixth surfaces and another end exposed on the fourth and fifth surfaces, and a peripheral electrode in a region between the first inner electrode and the third to sixth surfaces.

### CROSS REFERENCE TO RELATED APPLICATIONS

This application claims the benefit of priority to Japanese Patent Application No. 2024-087871 filed on May 30, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

With the recent reduction in size and thickness of electronic devices such as mobile phones and portable music players, multilayer ceramic capacitors mounted in such smaller and thinner electronic devices have also become smaller and thinner. In particular, multilayer ceramic capacitors that are becoming thinner are being used by being embedded in wiring boards, or being mounted in a very narrow gap even when mounted on the surface of a wiring board. As the multilayer ceramic capacitor thus becomes thinner and thinner, its mechanical strength decreases, leading to a demand to ensure the mechanical strength.

For example, in a multilayer ceramic capacitor described in Japanese Patent Application Publication No. 2021-103730, a region where adjacent inner electrodes face each other in a lamination direction has the largest thickness. Therefore, a large difference in dimension in the lamination direction between the region where no inner electrodes are disposed and the region where the inner electrodes are disposed may cause the surface of the multilayer ceramic capacitor to bend. This makes warping of a chip noticeable as the capacitor is made thinner. Since the multilayer ceramic capacitor described in Japanese Patent Application Publication No. 2021-103730 is substantially tetragonal with the length of two adjacent sides being about 0.9 to about 1.1 times, the distance between outer electrodes disposed on the diagonal line becomes longer. This may cause the capacitor to bend more significantly, leading to a possibility that the mechanical strength decreases due to pick-up by a nozzle during mounting.

### SUMMARY OF THE INVENTION

Example embodiments of the present invention provide thin tetragonal multilayer ceramic capacitors in each of which bending of the ceramic capacitor is reduced to reduce or prevent a decrease in mechanical strength.

A multilayer ceramic capacitor according to an example embodiment of the present invention includes a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction, and four outer electrodes on the multilayer body, in which about 0.85≤L/W≤ about 1.00 is satisfied, where L is a dimension of the multilayer ceramic capacitor in the first direction and W is a dimension of the multilayer ceramic capacitor in the second direction, the multilayer body includes a first inner electrode including one end exposed on the third surface and the fifth surface and another end exposed on the fourth surface and the sixth surface, a second inner electrode including one end exposed on the third surface and the sixth surface and another end exposed on the fourth surface and the fifth surface, and a peripheral electrode provided in a region between the first inner electrode and the third to sixth surfaces.

In a multilayer ceramic capacitor according to an example embodiment of the present invention, about 0.85≤L/W≤ about 1.00 is satisfied, where L is the dimension of the multilayer ceramic capacitor in the first direction and W is the dimension of the multilayer ceramic capacitor in the second direction, the multilayer body includes the first inner electrode including one end exposed on the third surface and the fifth surface and the another end exposed on the fourth surface and the sixth surface, the second inner electrode including one end exposed on the third surface and the sixth surface and the another end exposed on the fourth surface and the fifth surface, and the peripheral electrode provided in a region between the first inner electrode and the third to sixth surfaces. This makes it possible to provide thin tetragonal multilayer ceramic capacitors in each of which bending due to difference in level corresponding to the thickness of inner electrode layers between dielectric layers is reduced to reduce or prevent a decrease in mechanical strength.

Example embodiments of the present invention provide thin tetragonal multilayer ceramic capacitors in each of which bending is reduced to reduce or prevent a decrease in mechanical strength.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to a first example embodiment of the present invention.

FIG. 2 is a front view illustrating an example of the multilayer ceramic capacitor according to the first example embodiment of the present invention.

FIG. 3 is a side view illustrating an example of the multilayer ceramic capacitor according to the first example embodiment of the present invention.

FIG. 4 is a schematic sectional view taken along line IV-IV in FIG. 1.

FIG. 5 is a schematic sectional view taken along line V-V in FIG. 1.

FIG. 6 is a schematic sectional view taken along line VI-VI in FIG. 1.

FIG. 7 is a schematic sectional view taken along line VII-VII in FIG. 1.

FIG. 8A is a schematic sectional view taken along line VIIIA-VIIIA in FIG. 2.

FIG. 8B is a schematic sectional view taken along line VIIIB-VIIIB in FIG. 2.

FIG. 9 is an exploded perspective view of a multilayer body illustrated in FIG. 1.

FIG. 10A is a plan view illustrating another example of a peripheral electrode provided in the multilayer ceramic capacitor according to the first example embodiment of the present invention.

FIG. 10B is a plan view illustrating another example of the peripheral electrode provided in the multilayer ceramic capacitor according to the first example embodiment of the present invention.

FIG. 11A is a plan view illustrating another example of the peripheral electrode provided in the multilayer ceramic capacitor according to the first example embodiment of the present invention.

FIG. 11B is a plan view illustrating another example of the peripheral electrode provided in the multilayer ceramic capacitor according to the first example embodiment of the present invention.

FIG. 12A is a plan view illustrating another example of the peripheral electrode provided in the multilayer ceramic capacitor according to the first example embodiment of the present invention.

FIG. 12B is a plan view illustrating another example of the peripheral electrode provided in the multilayer ceramic capacitor according to the first example embodiment of the present invention.

FIG. 13 is a schematic sectional view illustrating an example of a multilayer ceramic capacitor according to a first modification of the first example embodiment of the present invention.

FIG. 14 is a schematic sectional view illustrating an example of a multilayer ceramic capacitor according to a second modification of the first example embodiment of the present invention.

FIG. 15 is a schematic sectional view illustrating an example of a multilayer ceramic capacitor according to a third modification of the first example embodiment of the present invention.

FIG. 16 is an external perspective view illustrating an example of a multilayer ceramic capacitor according to a second example embodiment of the present invention.

FIG. 17 is a front view illustrating an example of the multilayer ceramic capacitor according to the second example embodiment of the present invention.

FIG. 18 is a schematic sectional view taken along line XVIII-XVIII in FIG. 16 for explaining a structure of an example of the multilayer ceramic capacitor according to the second example embodiment of the present invention.

FIG. 19 is a schematic sectional view taken along line XIX-XIX in FIG. 16.

FIG. 20 is a schematic sectional view taken along line XX-XX in FIG. 16.

FIG. 21 is a schematic sectional view taken along line XXI-XXI in FIG. 16.

FIG. 22A is a schematic sectional view taken along line XXIIA-XXIIA in FIG. 17.

FIG. 22B is a schematic sectional view taken along line XXIIB-XXIIB in FIG. 17.

FIG. 23 is an exploded perspective view of a multilayer body illustrated in FIG. 16.

FIG. 24 is an external perspective view from one side illustrating an example of a multilayer ceramic capacitor according to a third example embodiment of the present invention.

FIG. 25 is an external perspective view from the other side illustrating an example of the multilayer ceramic capacitor according to the third example embodiment of the present invention.

FIG. 26 is a schematic sectional view taken along line XXVI-XXVI in FIG. 24.

FIG. 27 is a schematic sectional view taken along line XXVII-XXVII in FIG. 24.

FIG. 28 is a schematic sectional view taken along line XXVIII-XXVIII in FIG. 24.

FIG. 29 is a schematic sectional view taken along line XXIX-XXIX in FIG. 24.

### DETAILED DESCRIPTION OF THE EXAMPLE EMBODIMENTS

Example embodiments of the present invention will be described in detail below with reference to the drawings.

### A. First Example Embodiment

### 1. Multilayer Ceramic Capacitor

Next, an example of a multilayer ceramic capacitor 10 according to an example embodiment of the present invention will be described.

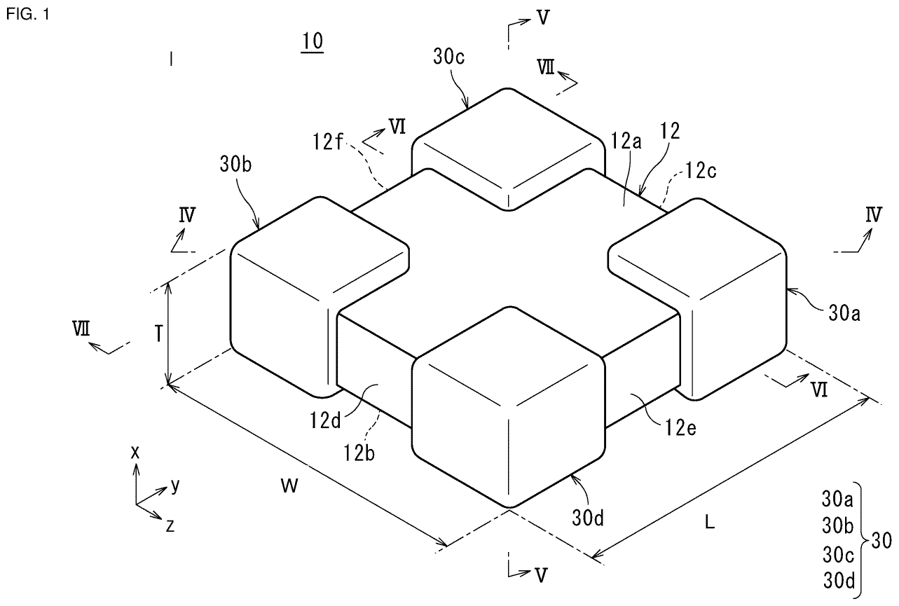

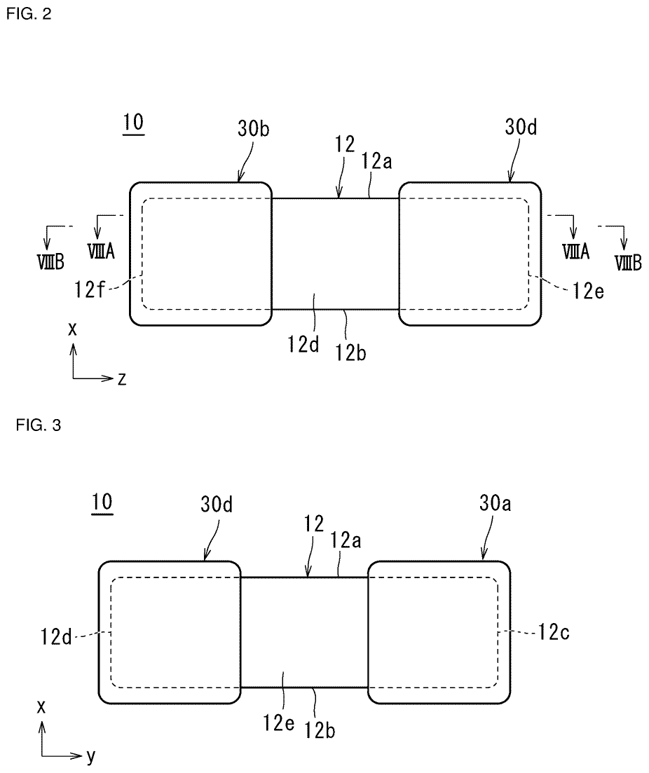

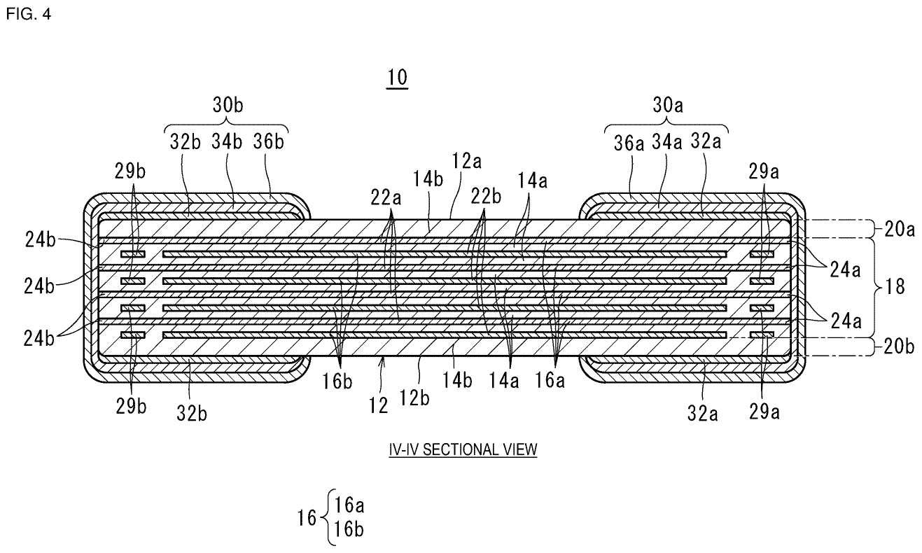

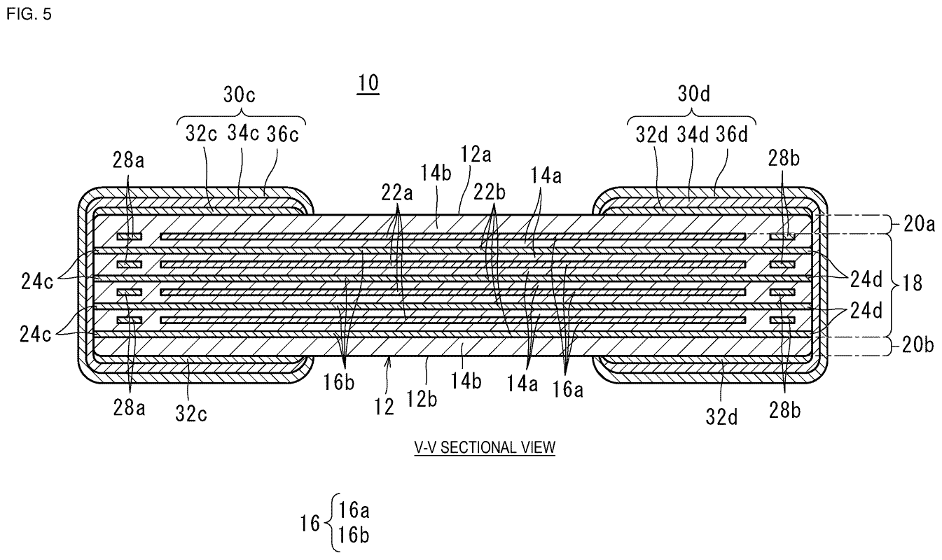

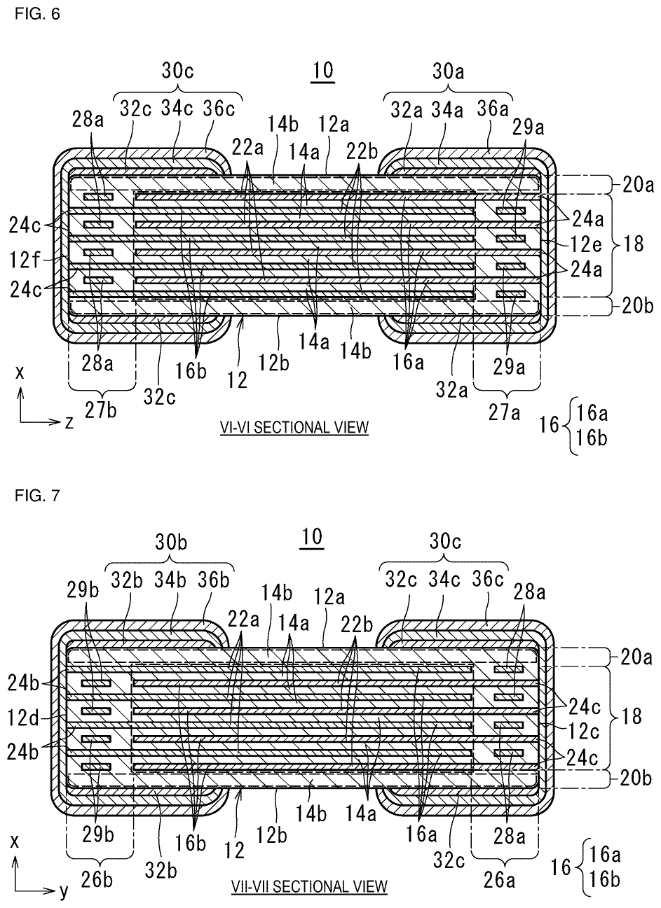

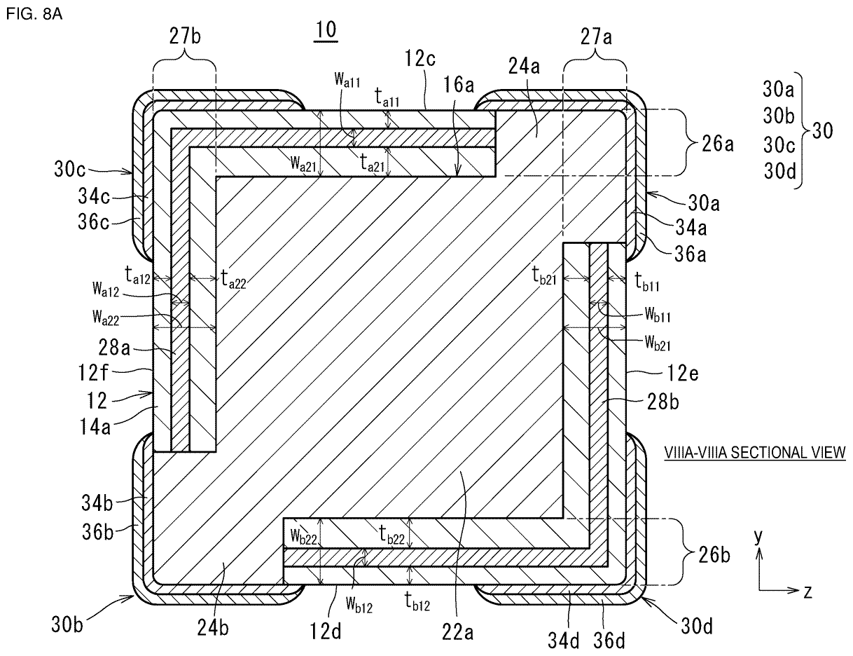

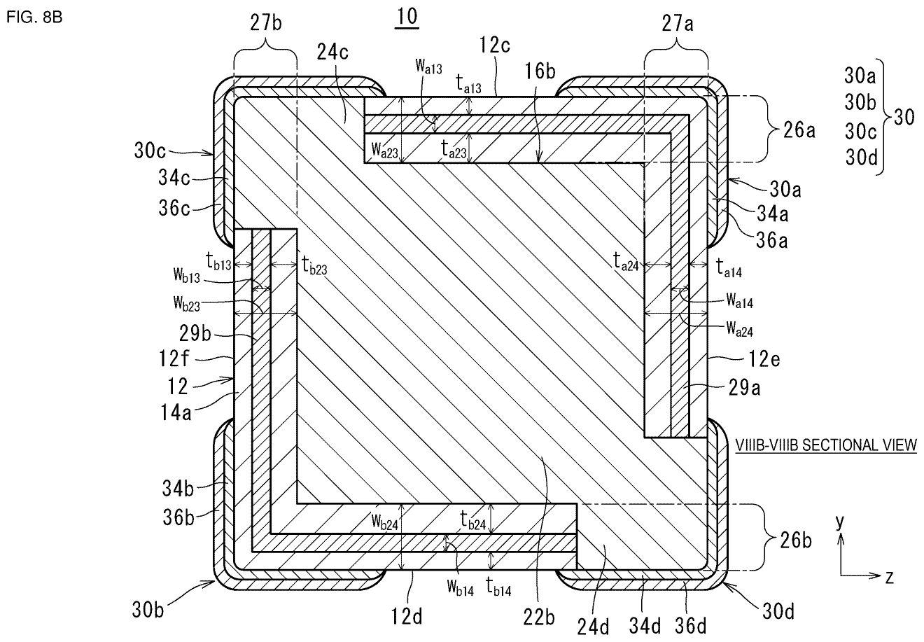

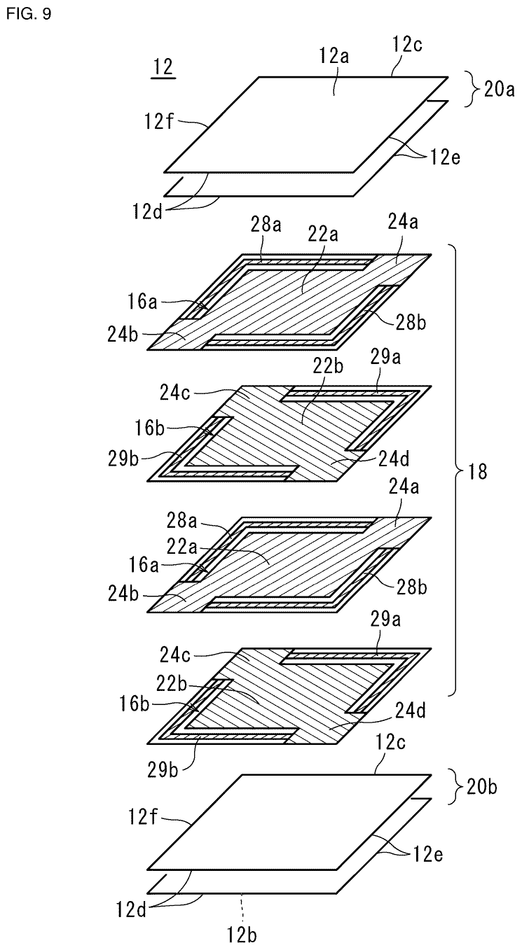

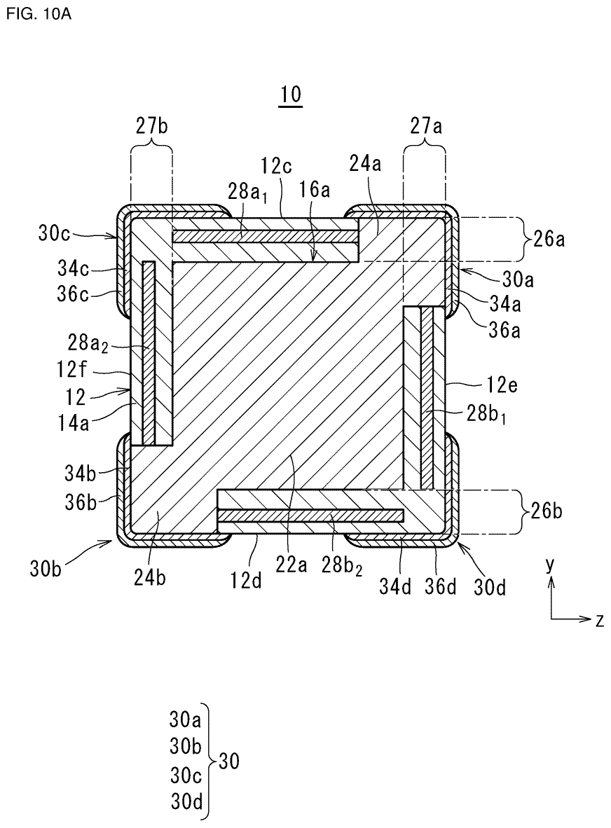

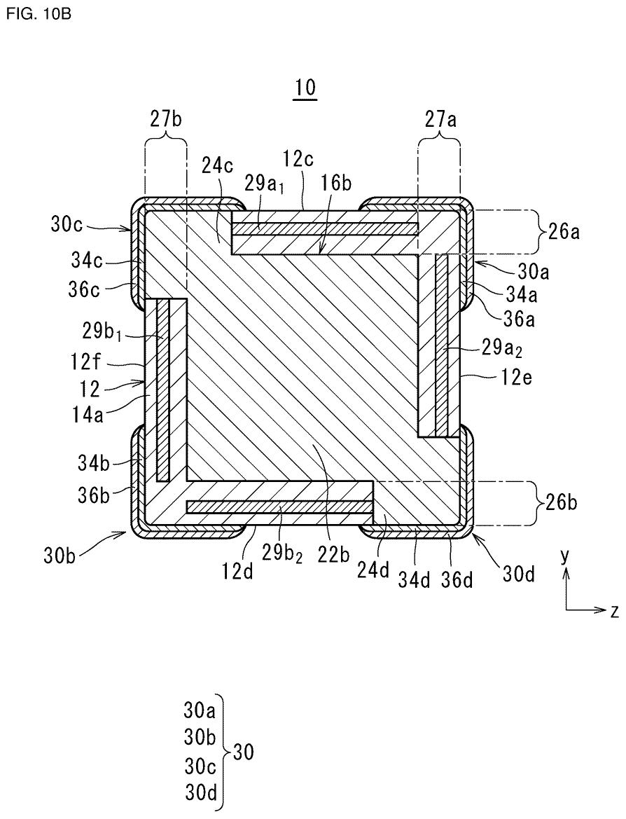

FIG. 1 is an external perspective view illustrating an example of a multilayer ceramic capacitor according to a first example embodiment of the present invention. FIG. 2 is a front view illustrating an example of the multilayer ceramic capacitor according to the first example embodiment of the present invention. FIG. 3 is a side view illustrating an example of the multilayer ceramic capacitor according to the first example embodiment of the present invention. FIG. 4 is a schematic sectional view taken along line IV-IV in FIG. 1. FIG. 5 is a schematic sectional view taken along line V-V in FIG. 1. FIG. 6 is a schematic sectional view taken along line VI-VI in FIG. 1. FIG. 7 is a schematic sectional view taken along line VII-VII in FIG. 1. FIG. 8A is a schematic sectional view taken along line VIIIA-VIIIA in FIG. 2. FIG. 8B is a schematic sectional view taken along line VIIIB-VIIIB in FIG. 2. FIG. 9 is an exploded perspective view of a multilayer body illustrated in FIG. 1.

The multilayer ceramic capacitor 10 includes a multilayer body 12 and a plurality of outer electrodes 30.

### Multilayer Body

The multilayer body 12 includes a first surface 12a and a second surface 12b facing each other in a lamination direction x, a third surface 12c and a fourth surface 12d facing each other in a first direction y that is orthogonal or r substantially orthogonal to the lamination direction x, and a fifth surface 12e and a sixth surface 12f facing each other in a second direction z that is orthogonal or substantially orthogonal to the lamination direction x and the first direction y. The lamination direction x is the direction connecting the first surface 12a and the second surface 12b of the multilayer body 12.

It is preferable that the corners and ridges of the multilayer body 12 are rounded. The corners are the portions where three adjacent surfaces of the multilayer body 12 intersect. The ridges are the portions where two adjacent surfaces of the multilayer body 12 intersect. Furthermore, the third surface 12c and the fourth surface 12d as well as the fifth surface 12e and the sixth surface 12f may have irregularities in a portion or in an entirety thereof.

Either the first surface 12a or the second surface 12b may be roughened.

The multilayer body 12 includes a plurality of dielectric layers 14 and a plurality of inner electrodes 16. The dielectric layers 14 include an inner dielectric layer 14a and an outer dielectric layer 14b. The inner electrodes 16 include a first inner electrode 16a and a second inner electrode 16b.

The multilayer body 12 also includes an inner layer portion 18, a first outer layer portion 20a located on the first surface 12a side, and a second outer layer portion 20b located on the second surface 12b side.

The first outer layer portion 20a is located on the first surface 12a side of the multilayer body 12, and is an assembly including the plurality of outer dielectric layers 14b located between the first surface 12a and the inner electrode 16 closest to the first surface 12a.

The second outer layer portion 20b is located on the second surface 12b side of the multilayer body 12, and is an assembly including the plurality of outer dielectric layers 14b located between the second surface 12b and the inner electrode 16 closest to the second surface 12b.

The region sandwiched between the first outer layer portion 20a and the second outer layer portion 20b is the inner layer portion 18.

The inner layer portion 18 includes the first inner electrode 16a including one end exposed to the third surface 12c and the fifth surface 12e and another end exposed to the fourth surface 12d and the sixth surface 12f, the second inner electrode 16b including one end exposed to the third surface 12c and the sixth surface 12f and another end exposed to the fourth surface 12d and the fifth surface 12e, and the inner dielectric layer 14a.

The dielectric layer 14 can be made of a dielectric material, for example. The dielectric material can be, for example, a dielectric ceramic made mainly of BaTiO₃, CaTio₃, SrTiO₃ or CaZro₃. It is also possible to use a material obtained by adding a sub-component such as, for example, a Mn compound, an Fe compound, a Cr compound, a Co compound or a Ni compound to these main components. The inner dielectric layer 14a and the outer dielectric layer 14b may be made of the same dielectric material, or may be made of different dielectric materials in order to separate the functions of the inner layer portion 18 and the outer layer portions 20a and 20b. At least one of, for example, Si, Mg, Ba, Mn, and the like may be added as an additive.

The inner dielectric layer 14a including a large amount of CaTio₃ or CaZro₃ as a dielectric component, for example, can reduce the occurrence of insulation breakdown between the first inner electrode 16a and the second inner electrode 16b. The inner dielectric layer 14a, without being limited to the above, can also be made mainly of SrTiO₃ or the like, for example. Alternatively, the inner dielectric layer 14a is preferably made of a material with a high dielectric constant, such as, for example, BaTiO₃, in order to increase the capacitance of the multilayer ceramic capacitor 10.

The dielectric layer 14 can include a plurality of crystal grains including, for example, a perovskite compound with BaTiO₃ as its basic structure.

The thinner the dielectric layer 14, the larger the capacitance of the capacitor. Therefore, the crystal grain size is, for example, preferably about 1 μm or less.

The number of the dielectric layers 14 to be laminated is not particularly limited, but is, for example, preferably 3 or more and 300 or less, including the first outer layer portion 20a and the second outer layer portion 20b. The thickness of the inner dielectric layer 14a is preferably, for example, about 0.4 μm or more and about 2.0 μm or less. The thickness of the outer dielectric layer 14b is preferably, for example, about 2.0 μm or more and about 100.0 μm or less.

A dimension L of the multilayer body 12 in the first direction y and a dimension W thereof in the second direction z satisfy about 0.85≤L/W≤ about 1.00, where the first direction y is the direction in which the third surface 12c and the fourth surface 12d face each other and the second direction z is the direction in which the fifth surface 12e and the sixth surface 12f face each other. Specifically, the multilayer body 12 has a tetragonal or substantially tetragonal shape.

### Inner Electrode

The inner electrodes 16 include a plurality of first inner electrodes 16a and a plurality of second inner electrodes 16b. The first inner electrodes 16a and the second inner electrodes 16b are alternately laminated with the dielectric layers 14 interposed therebetween.

The first inner electrode 16a is disposed on the surface of the inner dielectric layer 14a. The first inner electrode 16a faces the first surface 12a and the second surface 12b, includes a first counter electrode portion 22a facing the second inner electrode 16b, and is laminated in a direction connecting the first surface 12a and the second surface 12b.

The first inner electrode 16a extends to the third surface 12c and the fifth surface 12e of the multilayer body 12 by a first extended electrode portion 24a, and extends to the fourth surface 12d and the sixth surface 12f of the multilayer body 12 by a second extended electrode portion 24b. The width of the first extended electrode portion 24a extending to the third surface 12c may be the same or substantially the same as the width of the first extended electrode portion 24a extending to the fifth surface 12e. The width of the second extended electrode portion 24b extending to the fourth surface 12d may be the same or substantially the same as the width of the second extended electrode portion 24b extended to the sixth surface 12f.

The first inner electrode 16a is continuously extended to the third surface 12c and the fifth surface 12e of the multilayer body 12 by the first extended electrode portion 24a, and is continuously extended to the fourth surface 12d and the sixth surface 12f of the multilayer body 12 by the second extended electrode portion 24b. However, the first inner electrode 16a is not limited to the above and may be discontinuously extended.

The second inner electrode 16b is disposed on a surface of an inner dielectric layer 14a different from the inner dielectric layer 14a on which the first inner electrode 16a is disposed. The second inner electrode 16b faces the first surface 12a and the second surface 12b, includes a second counter electrode portion 22b facing the first inner electrode 16a, and is laminated in a direction connecting the first surface 12a and the second surface 12b.

The second inner electrode 16b is extended to the third surface 12c and the sixth surface 12f of the multilayer body 12 by a third extended electrode portion 24c, and is extended to the fourth surface 12d and the fifth surface 12e of the multilayer body 12 by a fourth extended electrode portion 24d. The width of the third extended electrode portion 24c extended to the third surface 12c may be the same or substantially the same as the width of the third extended electrode portion 24c extended to the sixth surface 12f. The width of the fourth extended electrode portion 24d extended to the fourth surface 12d may be the same or substantially the same as the width of the fourth extended electrode portion 24d extended to the fifth surface 12e.

The second inner electrode 16b is continuously extended to the third surface 12c and the sixth surface 12f of the multilayer body 12 by the third extended electrode portion 24c, and is continuously extended to the fourth surface 12d and the fifth surface 12e of the multilayer body 12 by the fourth extended electrode portion 24d. However, the second inner electrode 16b is not limited to the above and may be discontinuously extended.

When the multilayer ceramic capacitor 10 is viewed from the lamination direction x, a straight line connecting the first extended electrode portion 24a and the second extended electrode portion 24b of the first inner electrode 16a preferably intersects with a straight line connecting the third extended electrode portion 24c and the fourth extended electrode portion 24d of the second inner electrode 16b.

As illustrated in FIG. 7, the multilayer body 12 includes a side portion (W gap) 26a of the multilayer body 12 located between one end in the first direction y of the second counter electrode portion 22b of the second inner electrode 16b and the third surface 12c, and a side portion (W gap) 26b of the multilayer body 12 located between the other end in the first direction y of the first counter electrode portion 22a of the first inner electrode 16a and the fourth surface 12d.

Furthermore, as illustrated in FIG. 6, the multilayer body 12 includes an end portion (L gap) 27a of the multilayer body 12 located between one end in the second direction z of the second counter electrode portion 22b of the second inner electrode 16b and the fifth surface 12e, and a side portion (L gap) 27b of the multilayer body 12 located between the other end in the second direction z of the first counter electrode portion 22a of the first inner electrode 16a and the sixth surface 12f.

The first inner electrode 16a and the second inner electrode 16b can be made of an appropriate conductive material, such as metals, for example, Ni, Cu, Ag, Pd, and Au, or alloys including at least one of these metals, such as Ni—Cu alloy and Ag—Pd alloy, but are not limited thereto. The first inner electrode 16a and the second inner electrode 16b may be made of the same conductive material, or may be made of different conductive materials.

Sn included in the first inner electrode 16a and the second inner electrode 16b increases the potential barrier height at the interface between the inner electrode 16 and the dielectric layer 14, making it possible to reduce or prevent electric field concentration at the interface between the inner electrode 16 and the dielectric layer 14. This leads to improved high-temperature load reliability. In this case, for example, Sn can be sufficiently effective even when included in only one of the inner electrodes 16, the first inner electrode 16a or the second inner electrode 16b.

The total number of the first inner electrodes 16a and the second inner electrodes 16b is, for example, preferably 3 or more and 300 or less. The thickness of the first inner electrode 16a and the second inner electrode 16b is not particularly limited, but is preferably about 0.2 μm or more and about 2.0 μm or less, for example.

The multilayer body 12 of the multilayer ceramic capacitor 10 may have a configuration described below.

In the multilayer ceramic capacitor 10, the third surface 12c to the sixth surface 12f of the multilayer body 12 may be bent so as to be concave toward the center of the multilayer body 12 when viewed in the lamination direction x. In other words, the third surface 12c to the sixth surface 12f of the multilayer body 12 may be warped. In this case, the center of the bend and warpage is preferably near the center of the third surface 12c to the sixth surface 12f. This makes it possible to increase the distance between adjacent outer electrodes 30 to be described later, and thus to reduce the risk of conduction between the outer electrodes 30.

In addition, when viewed in at least one of the first direction y and the second direction z, the region where the inner electrode 16 is extended onto the third surface 12c to the sixth surface 12f preferably has an R from the first surface 12a to the second surface 12b. This increases the exposed area of the inner electrode 16, thus making it possible to improve the contact area between the inner electrode 16 and the outer electrode 30.

### Peripheral Electrode

The inner layer portion 18 of the multilayer body 12 further includes a first peripheral electrode 28 and a second peripheral electrode 29. The first peripheral electrode 28 is disposed around the first inner electrode 16a. The second peripheral electrode 29 is disposed around the second inner electrode 16b.

The first peripheral electrode 28 includes one first peripheral electrode 28a and another first peripheral electrode 28b.

The first peripheral electrodes 28a and 28b are laminated alternately with the inner dielectric layer 14a and are disposed on the same plane as the first inner electrode 16a disposed on the inner dielectric layer 14a. As illustrated in FIG. 8A, the first peripheral electrodes 28a and 28b are each disposed at a distance from the first inner electrode 16a.

The first peripheral electrode 28a is disposed in a region between the first inner electrode 16a and the third and sixth surfaces 12c and 12f. One end of the first peripheral electrode 28a is connected to the first extended electrode portion 24a of the first inner electrode 16a. The other end of the first peripheral electrode 28a is connected to the second extended electrode portion 24b of the first inner electrode 16a.

The first peripheral electrode 28b is disposed in a region between the first inner electrode 16a and the fourth and fifth surfaces 12d and 12e. One end of the first peripheral electrode 28b is connected to the first extended electrode portion 24a of the first inner electrode 16a. The other end of the first peripheral electrode 28a is connected to the second extended electrode portion 24b of the first inner electrode 16a.

A distance tan between the first peripheral electrode 28a and a portion closest to the third surface 12c is, for example, preferably about 5.0 μm or more and about 20 μm or less. A distance tₐ₁₂ between the first peripheral electrode 28a and a portion closest to the sixth surface 12f is, for example, preferably about 5.0 μm or more and about 20 μm or less.

A distance thu between the first peripheral electrode 28b and a portion closest to the fifth surface 12e is, for example, preferably about 5.0 μm or more and about 20 μm or less. A distance this between the first peripheral electrode 28b and a portion closest to the fourth surface 12d is, for example, preferably about 5.0 μm or more and about 20 μm or less. This makes it possible to increase the distance from moisture entering from the outside, and thus to reduce or prevent deterioration of moisture resistance.

The shortest distance tami between the first peripheral electrode 28a and the first inner electrode 16a on the third surface 12c side is, for example, preferably about 20 μm or more and about 80 μm or less. The shortest distance tam between the first peripheral electrode 28a and the first inner electrode 16a on the sixth surface 12f side is, for example, preferably about 20 μm or more and about 80 μm or less.

The shortest distance the between the first peripheral electrode 28b and the first inner electrode 16a on the fifth surface 12e side is, for example, preferably about 20 μm or more and about 80 μm or less. The shortest distance tb₂₂ between the first peripheral electrode 28b and the first inner electrode 16a on the fourth surface 12d side is, for example, preferably about 20 μm or more and about 80 μm or less. This makes it possible to prevent conduction between the first peripheral electrodes 28a and 28b close to the outside and the first inner electrode 16a, and thus to reduce or prevent insulation deterioration.

A width Wall of the first peripheral electrode 28a on the third surface 12c side is, for example, preferably about 1.0% or more and about 30% or less of a width wa₂₁ between the first inner electrode 16a and the third surface 12c. A width Wall of the first peripheral electrode 28a on the sixth surface 12f side is, for example, preferably about 1.0% or more and about 30% or less of a width Wa₂₂ between the first inner electrode 16a and the sixth surface 12f.

A width Woll of the first peripheral electrode 28b on the fifth surface 12e side is, for example, preferably about 1.0% or more and about 30% or less of a width W21 between the first inner electrode 16a and the fifth surface 12e. A width Wb₁₂ of the first peripheral electrode 18b on the fourth surface 12d side is, for example, preferably about 1.0% or more and about 30% or less of a width Wb₂₂ between the first inner electrode 16a and the fourth surface 12d.

The thickness difference between the first inner electrode 16a and the first peripheral electrodes 28a and 28b in the lamination direction is, for example, preferably about 90% or more and about 110% or less. This makes it possible to eliminate a difference in level corresponding to the thickness caused by the first inner electrode 16a and the second inner electrode 16b. Therefore, a structural defect due to peeling between the dielectric layers 14 in the multilayer body 12 can be reduced or prevented.

It is also preferable that the first inner electrode 16a and the first peripheral electrodes 28a and 28b have the same main component. When the first inner electrode 16a and the first peripheral electrodes 28a and 28b have the same main component, a structural defect due to internal shrinkage difference can be reduced or prevented in a firing process during manufacturing of the multilayer ceramic capacitor 10.

Furthermore, the same type of metal component as the first inner electrode 16a and the first peripheral electrodes 28a and 28b may be provided in the region between the first peripheral electrodes 28a and 28b and the first inner electrode 16a.

The second peripheral electrode 29 includes one second peripheral electrode 29a and another second peripheral electrode 29b.

The second peripheral electrodes 29a and 29b are laminated alternately with the inner dielectric layer 14a and are disposed on the same plane as the second inner electrode 16b disposed on the inner dielectric layer 14a. As illustrated in FIG. 8B, the second peripheral electrodes 29a and 29b are each disposed at a distance from the second inner electrode 16b.

The second peripheral electrode 29a is disposed in a region between the second inner electrode 16b and the third and fifth surfaces 12c and 12e. One end of the second peripheral electrode 29a is connected to the third extended electrode portion 24c of the second inner electrode 16b. The other end of the second peripheral electrode 29a is connected to the fourth extended electrode portion 24d of the second inner electrode 16b.

The second peripheral electrode 29b is disposed in a region between the second inner electrode 16b and the fourth and sixth surfaces 12d and 12f. One end of the second peripheral electrode 29b is connected to the third extended electrode portion 24c of the second inner electrode 16b. The other end of the second peripheral electrode 29b is connected to the fourth extended electrode portion 24d of the second inner electrode 16b.

A distance ta₁₃ between the second peripheral electrode 29a and a portion closest to the third surface 12c is, for example, preferably about 5.0 μm or more and 20 μm or about less. A distance ta₁₄ between the second peripheral electrode 29a and a portion closest to the fifth surface 12e is, for example, preferably about 5.0 μm or more and about 20 μm or less.

A distance this between the second peripheral electrode 29b and a portion closest to the fourth surface 12f is, for example, preferably about 5.0 μm or more and about 20 μm or less. A distance tb₁₄ between the second peripheral electrode 29b and a portion closest to the sixth surface 12d is, for example, preferably about 5.0 μm or more and about 20 μm or less. This makes it possible to increase the distance from moisture entering from the outside, and thus to reduce or prevent deterioration of moisture resistance.

The shortest distance ta₂₃ between the second peripheral electrode 29a and the second inner electrode 16b on the third surface 12c side is, for example, preferably about 20 μm or more and about 80 μm or less. The shortest distance ta₂₄ between the second peripheral electrode 29a and the second inner electrode 16b on the fifth surface 12e side is, for example, preferably about 20 μm or more and about 80 μm or less.

The shortest distance to 23 between the second peripheral electrode 29b and the second inner electrode 16b on the sixth surface 12f side is, for example, preferably about 20 μm or more and about 80 μm or less. The shortest distance to 24 between the second peripheral electrode 29b and the second inner electrode 16b on the fourth surface 12d side is, for example, preferably about 20 μm or more and about 80 μm or less. This makes it possible to prevent conduction between the second peripheral electrodes 29a and 29b close to the outside and the second inner electrode 16b, and thus to reduce or prevent insulation deterioration.

A width Wa₁₃ of the second peripheral electrode 29a on the third surface 12c side is, for example, preferably about 1.0% or more and about 30% or less of a width Wa₂₃ between the second inner electrode 16b and the third surface 12c. A width Wa₁₄ of the second peripheral electrode 29a on the fifth surface 12e side is, for example, preferably about 1.0% or more and about 30% or less of a width Wa₂₄ between the second inner electrode 16b and the fifth surface 12e.

A width Wp₁₃ of the second peripheral electrode 29b on the sixth surface 12f side is, for example, preferably about 1.0% or more and about 30% or less of a width Wp₂₃ between the second inner electrode 16b and the sixth surface 12f. A width Wb₁₄ of the second peripheral electrode 29b on the fourth surface 12d side is, for example, preferably about 1.0% or more and about 30% or less of a width Wo₂₄ between the second inner electrode 16b and the fourth surface 12d.

The thickness difference between the second inner electrode 16b and the second peripheral electrodes 29a and 29b in the lamination direction is, for example, preferably about 90% or more and about 110% or less. This makes it possible to eliminate difference in level corresponding to the thickness caused by the first inner electrode 16a and the second inner electrode 16b. Therefore, a structural defect due to peeling between the dielectric layers 14 in the multilayer body 12 can be reduced or prevented.

It is also preferable that the second inner electrode 16b and the second peripheral electrodes 29a and 29b have the same main component. When the second inner electrode 16b and the second peripheral electrodes 29a and 29b have the same main component, a structural defect due to internal shrinkage difference can be reduced or prevented in a firing process during manufacturing of the multilayer ceramic capacitor 10.

Furthermore, the same type of metal component as the second inner electrode 16b and the second peripheral electrodes 29a and 29b may be provided in the region between the second peripheral electrodes 29a and 29b and the second inner electrode 16b.

The structure of the peripheral electrodes 28 and 29 are not limited to the structure illustrated in FIGS. 8A and 8B, and may have a structure as described below.

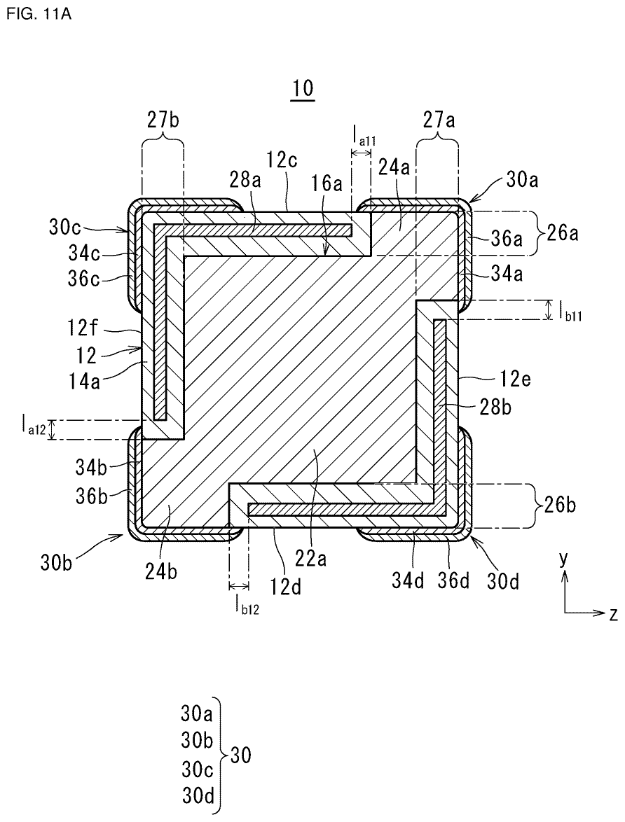

As illustrated in FIG. 10A, the first peripheral electrodes 28a and 28b do not have to be disposed on the line connecting the intersection of the third surface 12c and the sixth surface 12f and the intersection of the fourth surface 12d and the fifth surface 12e.

Thus, as illustrated in FIG. 10A, the one first peripheral electrode 28a may be further divided into a first peripheral electrode 28a1 and a first peripheral electrode 28a2. In this case, the first peripheral electrode 28a1 is disposed on the side portion 26a of the multilayer body 12 located on the third surface 12c side. The first peripheral electrode 28a2 is disposed at the end portion 27b of the multilayer body 12 located on the sixth surface 12f side.

The other first peripheral electrode 28b may be further divided into a first peripheral electrode 28b1 and a first peripheral electrode 28b2. In this case, the first peripheral electrode 28b1 is disposed at the end portion 27a of the multilayer body 12 located on the fifth surface 12e side. The first peripheral electrode 28b2 is disposed on the side portion 26b of the multilayer body 12 located on the fourth surface 12d side.

As illustrated in FIG. 10A, the first peripheral electrodes 28a and 28b do not have to be disposed about 1.0 μm or more and about 10 μm or less from the corner located at the longest part of the length of the first inner electrode 16a in a direction connecting the intersection of the third surface 12c and the sixth surface 12f and the intersection of the fourth surface 12d and the fifth surface 12e.

As illustrated in FIG. 10B, the second peripheral electrodes 29a and 29b do not have to be disposed on the line connecting the intersection of the third surface 12c and the fifth surface 12e and the intersection of the fourth surface 12d and the sixth surface 12f.

Thus, as illustrated in FIG. 10B, the one second peripheral electrode 29a may be further divided into a second peripheral electrode 29a1 and a second peripheral electrode 29a2. In this case, the second peripheral electrode 29a1 is disposed on the side portion 26a of the multilayer body 12 located on the third surface 12c side. The second peripheral electrode 29a2 is disposed at the end portion 27a of the multilayer body 12 located on the fifth surface 12e side.

The other second peripheral electrode 29b may be further divided into a second peripheral electrode 29b1 and a second peripheral electrode 29b2. In this case, the second peripheral electrode 29b1 is disposed at the end portion 27b of the multilayer body 12 located on the sixth surface 12f side. The second peripheral electrode 29b2 is disposed on the side portion 26b of the multilayer body 12 located on the fourth surface 12d side.

As illustrated in FIG. 10B, the second peripheral electrodes 29a and 29b do not have to be disposed about 1.0 μm or more and about 10 μm or less from the corner located at the longest portion of the length of the second inner electrode 16b in a direction connecting the intersection of the third surface 12c and the fifth surface 12e and the intersection of the fourth surface 12d and the sixth surface 12f.

Alternatively, the peripheral electrodes 28 and 29 may have the following structure.

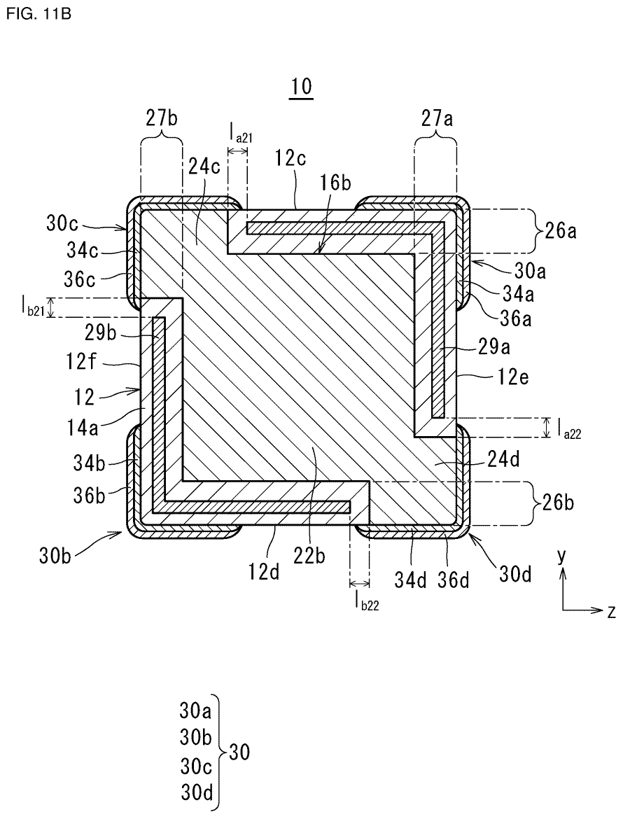

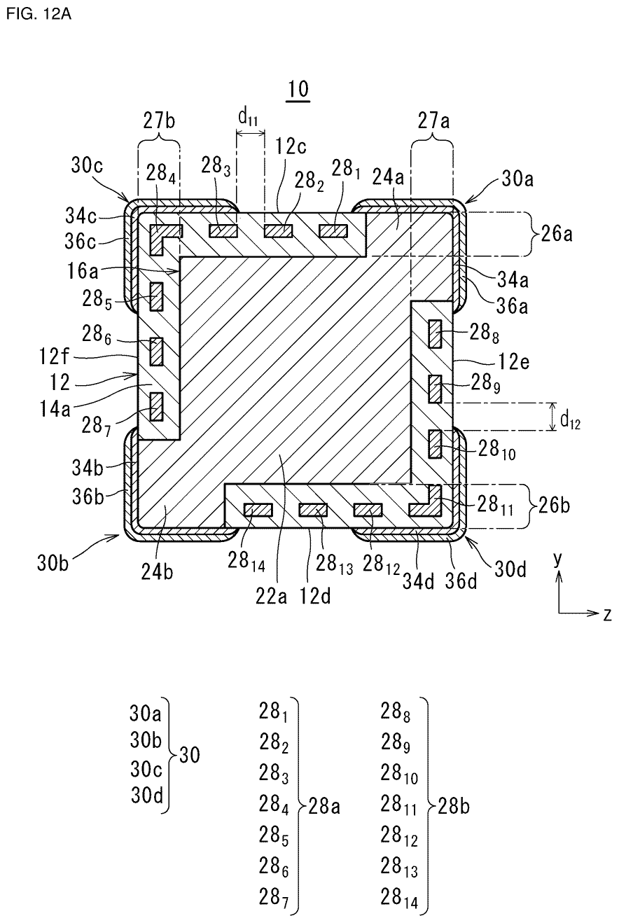

As illustrated in FIG. 11A, the first extended electrode portion 24a of the first inner electrode 16a exposed on the third surface 12c and the fifth surface 12e does not have to be connected to one end of the first peripheral electrode 28a. In this case, a distance lan between the first extended electrode portion 24a of the first inner electrode 16a and one end of the first peripheral electrode 28a is, for example, preferably about 1.0 μm or more and about 10 μm or less. Similarly, the second extended electrode portion 24b of the first inner electrode 16a exposed on the fourth surface 12d and the sixth surface 12f does not have to be connected to the other end of the first peripheral electrode 28a. In this case, a distance 1a₁: between the second extended electrode portion 24b of the first inner electrode 16a and the other end of the first peripheral electrode 28a is, for example, preferably about 1.0 μm or more and about 10 μm or less.

Similarly, the first extended electrode portion 24a of the first inner electrode 16a exposed on the third surface 12c and the fifth surface 12e does not have to be connected to one end of the first peripheral electrode 28b. In this case, a distance 1b11 between the first extended electrode portion 24a of the first inner electrode 16a and one end of the first peripheral electrode 28b is, for example, preferably about 1.0 μm or more and about 10 μm or less. Similarly, the second extended electrode portion 24b of the first inner electrode 16a exposed on the fourth surface 12d and the sixth surface 12f does not have to be connected to the other end of the first peripheral electrode 28b. In this case, a distance 1b₁₂ between the second extended electrode portion 24b of the first inner electrode 16a and the other end of the first peripheral electrode 28b is, for example, preferably about 1.0 μm or more and about 10 μm or less.

As illustrated in FIG. 11B, the third extended electrode portion 24c of the second inner electrode 16b exposed on the third surface 12c and the sixth surface 12f does not have to be connected to one end of the second peripheral electrode 29a. In this case, a distance l_{b12} between the third extended electrode portion 24c of the second inner electrode 16b and one end of the second peripheral electrode 29a is, for example, preferably about 1.0 μm or more and about 10 μm or less. Similarly, the fourth extended electrode portion 24d of the second inner electrode 16b exposed on the fourth surface 12d and the fifth surface 12e does not have to be connected to the other end of the second peripheral electrode 29a. In this case, a distance 1a₂₂ between the fourth extended electrode portion 24d of the second inner electrode 16b and the other end of the second peripheral electrode 29a is, for example, preferably about 1.0 μm or more and about 10 μm or less.

Similarly, the third extended electrode portion 24c of the second inner electrode 16b exposed on the third surface 12c and the sixth surface 12f does not have to be connected to one end of the second peripheral electrode 29b. In this case, a distance 1b21 between the third extended electrode portion 24c of the second inner electrode 16b and one end of the second peripheral electrode 29b is, for example, preferably about 1.0 μm or more and about 10 μm or less. Similarly, the fourth extended electrode portion 24d of the second inner electrode 16b exposed on the fourth surface 12d and the fifth surface 12e does not have to be connected to the other end of the second peripheral electrode 29b. In this case, a distance 1b22 between the fourth extended electrode portion 24d of the second inner electrode 16b and the other end of the second peripheral electrode 29b is, for example, preferably about 1.0 μm or more and about 10 μm or less.

Furthermore, the peripheral electrodes 28 and 29 may have the following structure.

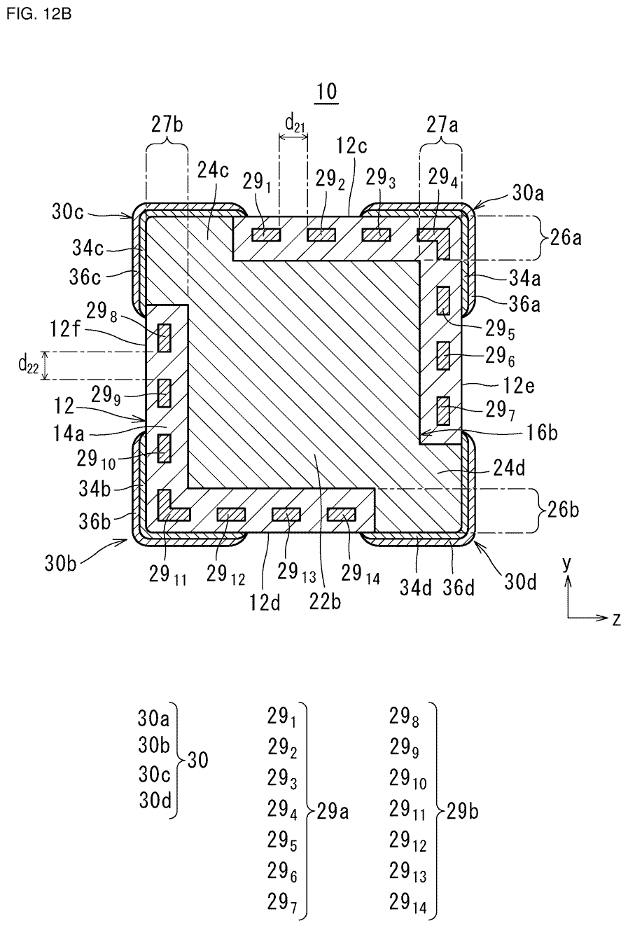

As illustrated in FIG. 12A, the first peripheral electrode 28a may include a plurality of peripheral electrodes 281 to 287, which may be arranged discontinuously. In the first peripheral electrode 28a, the plurality of peripheral electrodes 281 to 284 may be arranged discontinuously in the second direction z. In the first peripheral electrode 28a, the plurality of peripheral electrodes 284 to 287 may be arranged discontinuously in the first direction y.

Furthermore, the first peripheral electrode 28b may include a plurality of peripheral electrodes 288 to 2814, which may be arranged discontinuously. In the first peripheral electrode 28b, the plurality of peripheral electrodes 288 to 2811 may be arranged discontinuously in the first direction y. In the first peripheral electrode 28b, the plurality of peripheral electrodes 2811 to 2814 may be arranged discontinuously in the second direction z.

Such discontinuous arrangement of the first peripheral electrodes 28a and 28b can prevent moisture from reaching the first inner electrode 16a through the first peripheral electrodes 28a and 28b.

When the first peripheral electrode 28a is arranged discontinuously, a distance du between adjacent two of the peripheral electrodes 281 to 287 is, for example, preferably about 1.0 μm or more and about 10 μm or less. Furthermore, when the first peripheral electrode 28b is arranged discontinuously, a distance d₁₂ between adjacent two of the peripheral electrodes 288 to 2814 is, for example, preferably about 1.0 μm or more and about 10 μm or less. This achieves the effect of reducing or preventing a difference in level, since the periphery of the first inner electrode 16a is sufficiently filled even when the first peripheral electrodes 28a and 28b are each arranged discontinuously.

As illustrated in FIG. 12B, the second peripheral electrode 29a may include a plurality of peripheral electrodes 291 to 297, which may be arranged discontinuously. In the second peripheral electrode 29a, the plurality of peripheral electrodes 291 to 294 may be arranged discontinuously in the second direction z. Furthermore, in the second peripheral electrode 29a, the plurality of peripheral electrodes 294 to 297 may be arranged discontinuously in the first direction y.

Similarly, the second peripheral electrode 29b may include a plurality of peripheral electrodes 298 to 2914, which may be arranged discontinuously. In the second peripheral electrode 29b, the plurality of peripheral electrodes 298 to 2911 may be arranged discontinuously in the first direction y. Furthermore, in the second peripheral electrode 29b, the plurality of peripheral electrodes 2911 to 2914 may be arranged discontinuously in the second direction z.

Such discontinuous arrangement of the second peripheral electrodes 29a and 29b can prevent moisture from reaching the second inner electrode through 16b the second peripheral electrodes 29a and 29b.

When the second peripheral electrode 29a is arranged discontinuously, a distance d₂₁ between adjacent two of the peripheral electrodes 291 to 297 is, for example, preferably about 1.0 μm or more and about 10 μm or less. Furthermore, when the second peripheral electrode 29b is arranged discontinuously, a distance d₂₂ between adjacent two of the peripheral electrodes 298 to 2914 is, for example, preferably about 1.0 μm or more and about 10 μm or less. This achieves the effect of suppressing difference in level, since the periphery of the second inner electrode 16b is sufficiently filled even when the second peripheral electrodes 29a and 29b are each arranged discontinuously.

### Outer Electrode

As illustrated in FIGS. 1 to 7, the outer electrode 30 is provided on the multilayer body 12.

The outer electrode 30 includes a plurality of outer electrodes 30 connected to the first inner electrode 16a and the second inner electrode 16b. The outer electrode 30 includes a first outer electrode 30a, a second outer electrode 30b, a third outer electrode 30c, and a fourth outer electrode 30d.

The first outer electrode 30a is disposed on the third surface 12c and the fifth surface 12e so as to cover the first extended electrode portion 24a of the first inner electrode 16a, and also to cover a part of the first surface 12a and a portion of the second surface 12b. The first outer electrode 30a is electrically connected to the first extended electrode portion 24a of the first inner electrode 16a.

The second outer electrode 30b is disposed on the fourth surface 12d and the sixth surface 12f so as to cover the second extended electrode portion 24b of the first inner electrode 16a, and also to cover a part of the first surface 12a and a portion of the second surface 12b. The second outer electrode 30b is electrically connected to the second extended electrode portion 24b of the first inner electrode 16a.

The third outer electrode 30c is disposed on the third surface 12c and the sixth surface 12f so as to cover the third extended electrode portion 24c of the second inner electrode 16b, and also to cover a portion of the first surface 12a and a part of the second surface 12b. The third outer electrode 30c is electrically connected to the third extended electrode portion 24c of the second inner electrode 16b.

The fourth outer electrode 30d is disposed on the fourth surface 12d and the fifth surface 12e so as to cover the fourth extended electrode portion 24d of the second inner electrode 16b, and also to cover a portion of the first surface 12a and a part of the second surface 12b. The fourth outer electrode 30d is electrically connected to the fourth extended electrode portion 24d of the second inner electrode 16b.

In the multilayer body 12, the first counter electrode portion 22a of the first inner electrode 16a and the second counter electrode portion 22b of the second inner electrode 16b face each other across the inner dielectric layer 14a, thus generating an electrostatic capacitance. Therefore, the electrostatic capacitance can be obtained between the first outer electrode 30a and the second outer electrode 30b, to which the first inner electrode 16a is connected, and the third outer electrode 30c and the fourth outer electrode 30d, to which the second inner electrode 16b is connected, thus providing the capacitor characteristics.

It is preferable that the first outer electrode 30a, the second outer electrode 30b, the third outer electrode 30c, and the fourth outer electrode 30d each include a thin film layer 32, an underlying plating layer 34, and a surface plating layer 36, for example.

In other words, for example, the first outer electrode 30a preferably includes a first thin film layer 32a, a first underlying plating layer 34a, and a first surface plating layer 36a. The second outer electrode 30b preferably includes a second thin film layer 32b, a second underlying plating layer 34b, and a second surface plating layer 36b. The third outer electrode 30c preferably includes a third thin film layer 32c, a third underlying plating layer 34c, and a third surface plating layer 36c. The fourth outer electrode 30d preferably includes a fourth thin film layer 32d, a fourth underlying plating layer 34d, and a fourth surface plating layer 36d.

### Thin Film Layer

The thin film layer 32 includes the first thin film layer 32a, the second thin film layer 32b, the third thin film layer 32c, and the fourth thin film layer 32d.

The first thin film layer 32a partially covers the first surface 12a and the second surface 12b of the multilayer body 12 on the third surface 12c side and the fifth surface 12e side, but does not cover the third surface 12c and the fifth surface 12e of the multilayer body 12.

The second thin film layer 32b partially covers the first surface 12a and the second surface 12b of the multilayer body 12 on the fourth surface 12d side and the sixth surface 12f side, but does not cover the fourth surface 12d and the sixth surface 12f.

The third thin film layer 32c partially covers the first surface 12a and the second surface 12b of the multilayer body 12 on the third surface 12c side and the sixth surface 12f side, but does not cover the third surface 12c and the sixth surface 12f.

The fourth thin film layer 32d partially covers the first surface 12a and the second surface 12b of the multilayer body 12 on the fourth surface 12d side and the fifth surface 12e side, but does not cover the fourth surface 12d and the fifth surface 12e.

The first to fourth thin film layers 32a to 32d are each preferably formed by, for example, depositing metal particles by sputtering, vapor deposition or the like. This allows the first to fourth thin film layers 32a to 32d to have a thickness of, for example, about 1 μm or less in the direction connecting the first surface 12a and the second surface 12b of the multilayer body 12. The dimension of the multilayer ceramic capacitor 10 in the lamination direction x can thus be sufficiently reduced, making it possible to reduce the height of the multilayer ceramic capacitor 10.

The dimension of the first to fourth thin film layers 32a to 32d in the lamination direction x can be measured as follows.

Specifically, for example, in the case of forming the thin film layers by depositing metal particles, a fluorescent X-ray device can be used to calculate the thickness from the concentration of a specified element using a calibration curve method for the corresponding metal species. Alternatively, for example, a method can be used in which an FIB cross-section of a component is observed using a scanning microscope, and the thickness is measured from the actual observed image.

When the first to fourth thin film layers 32a to 32d are formed by a thin film formation method, these thin film layers are preferably made of metal such as Cu or Ni, for example.

The thin film layer 32 of the multilayer ceramic capacitor 10 illustrated in FIG. 1 is formed by depositing metal particles by sputtering, for example. In this case, when the thickness of the thin film layer 32 is about 1 μm or less, the dimension in the lamination direction x can be sufficiently reduced.

The first to fourth thin film layers 32a to 32d can be formed taking into consideration their respective functions. For example, taking into consideration the adhesion to the multilayer body 12, NiCr or NiCu is preferably used as the main component. Furthermore, the first to fourth thin film layers 32a to 32d may have a multilayer structure such as, for example, a two-layer structure of NiCr and NiCu.

The thin film layer 32 may be formed by, for example, screen printing or the like and include a dielectric material and a metal component. In this case, the thin film layer 32 and the ceramic of the multilayer body 12 are fixed to each other, and the fixing strength between the multilayer body 12 and the outer electrode 30 can be further improved. In this case, the thin film layer 32 may include a ceramic component having the same main component as the inner dielectric layer 14a, in addition to the metal component. The ceramic component included in the thin film layer 32 can reduce the difference in thermal expansion coefficient between the multilayer body 12 and the thin film layer 32, thus relaxing the stress applied to the thin film layer 32. However, the metal component may be other metal components, without being limited to Cu and Ni, and a glass component may be included in addition to the ceramic component. Examples of the glass component include oxides of Ba (barium), Sr (strontium), Si (silicon), Ca (calcium), Zn, Al, and B (boron). Examples of other metal components include Mg, Cr, Sr, Al, Na, Fe, and the like. The thin film layer 32 may have a discontinuous shape. The term “discontinuous” means that the thin film layer 32 is formed discontinuously when viewed from a direction perpendicular or substantially perpendicular to the longitudinal direction.

For example, in the case of forming the thin film layer 32 by using a ceramic-containing material, a method is used in which a photograph of a cross section is taken using a digital microscope (manufactured by Keyence Corporation: VHX-5000) after polishing the cross section, and then the thickness is calculated from the photograph of the cross section. There is also another method in which the thickness and the like are measured from an actual observed image of an FIB cross-section of a component, using a scanning microscope.

### Underlying Plating Layer

The underlying plating layer 34 includes a first underlying plating layer 34a, a second underlying plating layer 34b, a third underlying plating layer 34c, and a fourth underlying plating layer 34d.

The first underlying plating layer 34a covers the first thin film layer 32a as well as the third surface 12c and the fifth surface 12e of the multilayer body 12.

The second underlying plating layer 34b covers the second thin film layer 32b as well as the fourth surface 12d and the sixth surface 12f of the multilayer body 12.

The third underlying plating layer 34c covers the third thin film layer 32c as well as the third surface 12c and the sixth surface 12f of the multilayer body 12.

The fourth underlying plating layer 34d covers the fourth thin film layer 32d as well as the fourth surface 12d and the fifth surface 12e of the multilayer body 12.

The underlying plating layer 34 includes at least one of, for example, Cu, Ni, Sn, Ag, Pd, Ag—Pd alloy, Au, and the like. The underlying plating layer 34 is, for example, preferably Cu plating. In this case, the underlying plating layer 34 may be directly connected to the inner electrode 16. The underlying plating layer 34 may also include, for example, another Cu plating layer with a different particle size.

The underlying plating layer 34 preferably has a thickness of, for example, about 1 μm or more and about 10 μm or less.

### Surface Plating Layer

The surface plating layer 36 includes a first surface plating layer 36a, a second surface plating layer 36b, a third surface plating layer 36c, and a fourth surface plating layer 36d.

The first surface plating layer 36a covers the first underlying plating layer 34a. The second surface plating layer 36b covers the second underlying plating layer 34b. The third surface plating layer 36c covers the third underlying plating layer 34c. The fourth surface plating layer 36d covers the fourth underlying plating layer 34d.

For example, the surface plating layer 36 may include only Sn plating, or may include Ni plating, Sn plating, or have a two-layer structure including Ni plating and Cu plating.

The surface plating layer 36 preferably has a thickness of, for example, about 0.5 μm or more and about 10 μm or less.

The plating layer may include only the underlying plating layer 34. In this case, the first underlying plating layer 34a covers the first thin film layer 32a, and the second underlying plating layer 34b covers the second thin film layer 32b. Similarly, the third underlying plating layer 34c covers the third thin film layer 32c, and the fourth underlying plating layer 34d covers the fourth thin film layer 32d.

The plating layer preferably includes at least one type of metal of, for example, Cu, Ni, Sn, Pb, Au, Ag, Pd, Bi, Zn, and the like or an alloy including the metal. The plating layer preferably does not include glass.

The metal ratio per unit volume of the plating layer is, for example, preferably about 99 volume % or more.

The thickness of each plating layer is, for example, preferably about 0.5 μm or more and about 10.0 μm or less.

L dimension is the dimension in the first direction y of the multilayer ceramic capacitor 10 including the multilayer body 12 and the outer electrode 30. T dimension is the dimension in the lamination direction x of the multilayer ceramic capacitor 10 including the multilayer body 12 and the outer electrode 30. W dimension is the dimension in the second direction z of the multilayer ceramic capacitor 10 including the multilayer body 12 and the outer electrode 30.

The dimensions of the multilayer ceramic capacitor 10 are, for example, preferably such that the L dimension in the first direction y is about 0.2 mm or more and about 3.2 mm or less, the T dimension in the lamination direction x is about 0.04 mm or more and about 0.22 mm or less, and the W dimension in the second direction z is about 0.2 mm or more and about 3.2 mm or less. The dimensions of the multilayer ceramic capacitor 10 preferably satisfy about 0.85≤L/W≤ about 1.00, for example. This allows the multilayer body 12 to have a tetragonal or substantially tetragonal shape, thus improving the degree of freedom of mounting.

In the multilayer ceramic capacitor 10 illustrated in FIG. 1, the dimension L in the first direction y and the dimension W in the second direction z of the multilayer body 12 satisfy about 0.85≤L/W≤ about 1.00, for example. The first peripheral electrode 28a is disposed in the region between the first inner electrode 16a and the third and sixth surfaces 12c and 12f. The first peripheral electrode 28b is disposed in the region between the first inner electrode 16a and the fourth and fifth surfaces 12d and 12e. This makes it possible to provide a thin tetragonal multilayer ceramic capacitor 10 in which bending due to difference in level corresponding to the thickness of the inner electrode layers between the dielectric layers is reduced, thus preventing a decrease in mechanical strength.

### 2. Modifications

(1) First Modification

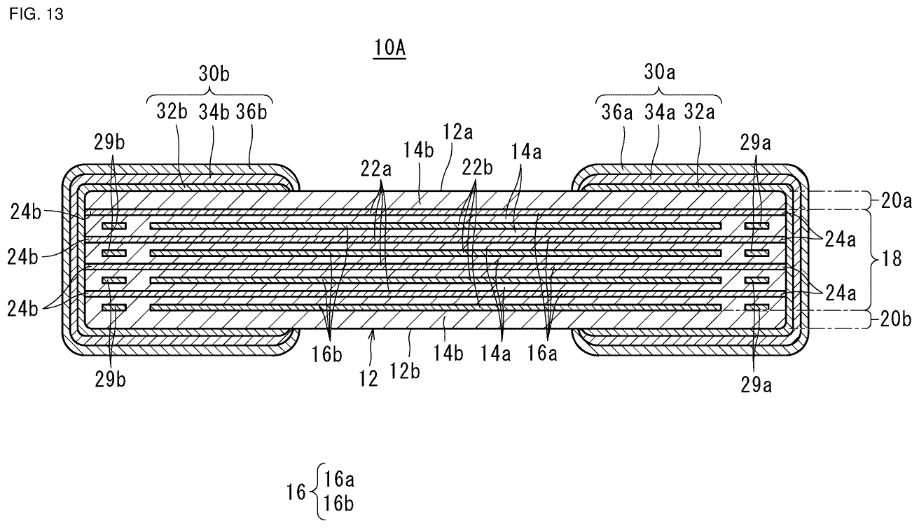

Next, an example of a multilayer ceramic capacitor 10A according to a first modification of the first example embodiment of the present invention will be described. FIG. 13 is a schematic sectional view illustrating an example of the multilayer ceramic capacitor according to the first modification of the first example embodiment of the present invention. However, the same or corresponding configurations as those in FIGS. 1 to 7 will be denoted by the same reference numerals, and detailed description thereof will be omitted.

In the multilayer ceramic capacitor 10A according to the first modification, as illustrated in FIG. 13, a thin film layer 32 wraps around to each side surface of a multilayer body 12.

Specifically, a first thin film layer 32a of a first outer electrode 30a wraps around from a first surface 12a and a second surface 12b so as to partially cover the first surface 12a and the second surface 12b and to cover a third surface 12c and a fifth surface 12e.

A second thin film layer 32b of a second outer electrode 30b wraps around from the first surface 12a and the second surface 12b so as to partially cover the first surface 12a and the second surface 12b and to cover a fourth surface 12d and a sixth surface 12f.

Although not illustrated, the same applies to a third thin film layer 32c of a third outer electrode 30c and a fourth thin film layer 32d of a fourth outer electrode 30d.

The first thin film layer 32a is electrically connected directly to a first extended electrode portion 24a of a first inner electrode 16a exposed from the third surface 12c and the fifth surface 12e. The second thin film layer 32b is electrically connected directly to a second extended electrode portion 24b of the first inner electrode 16a exposed from the fourth surface 12d and the sixth surface 12f.

Although not illustrated, the third thin film layer 32c is electrically connected directly to a third extended electrode portion 24c of a second inner electrode 16b. The fourth thin film layer 32d is electrically connected directly to a fourth extended electrode portion 24d of the second inner electrode 16b.

The first thin film layer 32a may be configured so that a thin film layer formed on the first surface 12a and the second surface 12b and a thin film layer on the third surface 12c and the fifth surface 12e are connected continuously or discontinuously. The second thin film layer 32b may be configured so that a thin film layer formed on the first surface 12a and the second surface 12b and a thin film layer on the fourth surface 12d and the sixth surface 12f are connected continuously or discontinuously.

The same applies to the third thin film layer 32c of the third outer electrode 30c and the fourth thin film layer 32d of the fourth outer electrode 30d.

The multilayer ceramic capacitor 10A according to the first modification illustrated in FIG. 13 has the same or substantially the same advantageous effects as those of the multilayer ceramic capacitor 10 described above.

### (2) Second Modification

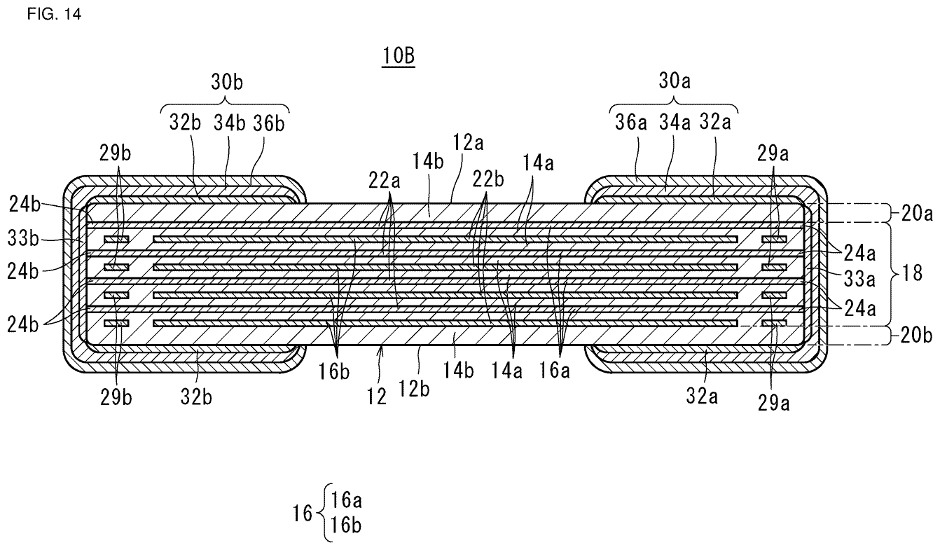

Next, an example of a multilayer ceramic capacitor 10B according to a second modification of the first example embodiment of the present invention will be described. FIG. 14 is a schematic sectional view illustrating an example of the multilayer ceramic capacitor according to the second modification of the first example embodiment of the present invention. However, the same or corresponding configurations as those in FIGS. 1 to 7 will be denoted by the same reference numerals, and detailed description thereof will be omitted.

As illustrated in FIG. 14, an outer electrode 30 of the multilayer ceramic capacitor 10B according to the second modification of the first example embodiment includes a direct plating layer 33.

### Direct Plating Layer

A first outer electrode 30a includes a first direct plating layer 33a. A second outer electrode 30b includes a second direct plating layer 33b. Although not illustrated, a third outer electrode 30c includes a third direct plating layer, and a fourth outer electrode 30d includes a fourth direct plating layer.

The first direct plating layer 33a covers a portion of a third surface 12c and a portion of a fifth surface 12e of a multilayer body 12, as well as a ridge portion sandwiched therebetween. The first direct plating layer 33a is electrically connected directly to a first extended electrode portion 24a of a first inner electrode 16a.

The second direct plating layer 33b covers a portion of a fourth surface 12d and a portion of a sixth surface 12f of the multilayer body 12, as well as a ridge portion sandwiched therebetween. The second direct plating layer 33b is electrically connected directly to a second extended electrode portion 24b of the first inner electrode 16a.

Although not illustrated, the same applies to the third direct plating layer of the third outer electrode 30c and the fourth direct plating layer of the fourth outer electrode 30d.

The first direct plating layer 33a of the first outer electrode 30a preferably includes an upper end arranged so as to overlap the underside of the first thin film layer 32a on the ridge portion defined by the first surface 12a and the third and fifth surfaces 12c and 12e of the multilayer body 12.

The second direct plating layer 33b of the second outer electrode 30b preferably includes an upper end arranged so as to overlap the underside of the second thin film layer 32b on the ridge portion formed by the first surface 12a and the fourth and sixth surfaces 12d and 12f of the multilayer body 12.

Although not illustrated, the same applies to the third direct plating layer of the third outer electrode 30c and the fourth direct plating layer of the fourth outer electrode 30d.

The first direct plating layer 33a may be partially disposed so as to wrap around to the second surface 12b. The second direct plating layer 33b may be partially disposed so as to wrap around to the second surface 12b. The third direct plating layer and the fourth direct plating layer may also be partially disposed so as to wrap around to the second surface 12b.

The upper ends of the first direct plating layer 33a and the second direct plating layer 33b may be disposed so as to be spaced apart from the first thin film layer 32a and the second thin film layer 32b. The upper ends of the third direct plating layer and the fourth direct plating layer may be disposed so as to be spaced apart from the third thin film layer 32c and the fourth thin film layer 32d.

The direct plating layer 33 is not particularly limited as long as it includes at least one type of metal including, for example, Cu, Ni, Ag, Pd, Ag—Pd alloy, Au, and the like as the main metal component. When the first inner electrode 16a and the second inner electrode 16b are made, for example, using Ni, Cu plating having good bondability with Ni is preferably used for the direct plating layer 33.

The direct plating layer 33 is formed by plating growth from the inner electrode 16.

Each direct plating layer 33 preferably has a thickness of, for example, about 0.5 μm or more and about 10.0 μm or less.

The multilayer ceramic capacitor 10B according to the present modification illustrated in FIG. 14 has the same or substantially the same advantageous effects as those of the multilayer ceramic capacitor 10 described above.

Specifically, the formation of the direct plating layer 33 on each side surface of the multilayer body 12 makes it possible to further reduce the thickness in the lamination direction of the outer electrode 30 on the first surface 12a and the second surface 12b. This makes it possible to provide a multilayer ceramic capacitor with a further reduced height without impairing mountability during mounting.

### (3) Third Modification

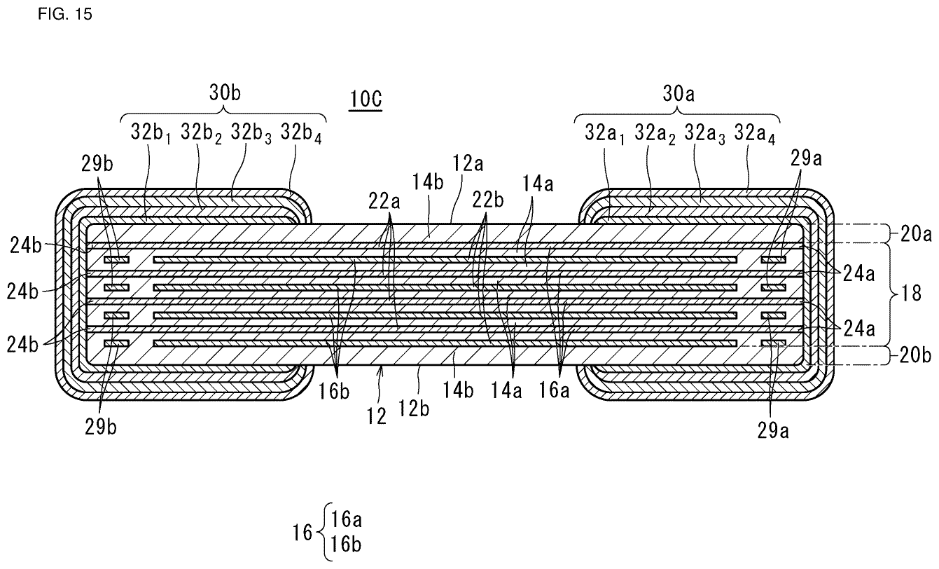

Next, a multilayer ceramic capacitor 10C according to a third modification of the first example embodiment of the present invention will be described. FIG. 15 is a schematic sectional view illustrating an example of the multilayer ceramic capacitor according to the third modification of the first example embodiment of the present invention. However, the same or corresponding configurations as those in FIGS. 1 to 7 will be denoted by the same reference numerals, and detailed description thereof will be omitted.

An outer electrode 30 of the multilayer ceramic capacitor 10C according to the third modification includes no plating layer and includes a plurality of thin film layers. In the multilayer ceramic capacitor 10C illustrated in FIG. 15, for example, a first outer electrode 30a includes no plating layer and includes only four thin film layers 32a1 to 32a4, and a second outer electrode 30b includes no plating layer and includes only four thin film layers 32b1 to 32b4.

In the first outer electrode 30a, the thin film layer 32a1 wraps around and cover the third surface 12c and the fifth surface 12e from the first surface 12a. The thin film layer 32a2, the thin film layer 32a3, and the thin film layer 32a4 are then provided in this order on the surface of the thin film layer 32a1.

In the second outer electrode 30b, the thin film layer 32b1 wraps around and cover the fourth surface 12d and the sixth surface 12f from the first surface 12a. The thin film layer 32b2, the thin film layer 32b3, and the thin film layer 32b4 are then provided in this order on the surface of the thin film layer 32b1.

Although not illustrated, the same applies to the third thin film layer 32c of the third outer electrode 30c and the fourth thin film layer 32d of the fourth outer electrode 30d.

In the first outer electrode 30a, each edge portion of the four thin film layers 32a1 to 32a4 near the center of the multilayer body 12 may or may not cover the edge portion on the lower layer side. Similarly, in the second outer electrode 30b, each edge portion of the four thin film layers 32bi to 32b4 near the center of the multilayer body 12 may or may not cover the edge portion on the lower layer side.

Although not illustrated, the same applies to the third thin film layer 32c of the third outer electrode 30c and the fourth thin film layer 32d of the fourth outer electrode 30d.

The multilayer ceramic capacitor 10C according to the present modification illustrated in FIG. 15 has the same or substantially the same advantageous effects as those of the multilayer ceramic capacitor 10 described above, and also has the following effect.

Specifically, the multilayer ceramic capacitor 10C includes no plating layer, and the first outer electrode 30a includes only the thin film layers 32a1 to 32a4, and the second outer electrode 30b includes only the thin film layers 32bi to 32b4. In addition, the third outer electrode 30c and the fourth outer electrode 30d also have the same configuration. This makes it possible to reduce the dimensions of the multilayer ceramic capacitor by reducing the T dimension in the lamination direction x, the L dimension in the first direction y, and the W dimension in the second direction z.

### 3. Method for Manufacturing Multilayer Ceramic Capacitor

An example of a method for manufacturing a multilayer ceramic capacitor according to the first example embodiment will be described below.

First, a dielectric sheet, a conductive paste for inner electrodes, and a conductive paste for peripheral electrodes are prepared. The dielectric sheet, the conductive paste for inner electrodes, and the conductive paste for peripheral electrodes include a binder and a solvent. Known binders and solvents can be used.

Next, predetermined patterns are printed on the dielectric sheet using the conductive paste for inner electrodes and the conductive paste for peripheral electrodes by inkjet printing, gravure printing, or the like, for example. A dielectric sheet on which a first inner electrode pattern and a first peripheral electrode pattern are formed and a dielectric sheet on which a second inner electrode pattern and a second peripheral electrode pattern are formed are thus prepared. Thereafter, the sheet on which the patterns of the first inner electrode and the first peripheral electrode are printed and the sheet on which the patterns of the second inner electrode and the second peripheral electrode are printed are laminated to form a portion to define an inner layer portion 18.

When the patterns are printed using each conductive paste, the pattern using the conductive paste for inner electrodes is printed first, and then the pattern using the conductive paste for peripheral electrodes is printed.

In the case of forming the printing pattern of the inner electrodes by, for example, gravure printing, a gravure plate used in the gravure printing is designed to form the graphic pattern of the first inner electrode and then changed to the structure corresponding to the graphic pattern of the second inner electrode. This makes it possible to form the desired respective inner electrodes. In the case of forming the printing pattern of the peripheral electrodes by gravure printing, the gravure plate used in the gravure printing is designed to form the graphic pattern of the first peripheral electrode and then changed to the structure corresponding to the graphic pattern of the second peripheral electrode. This makes it possible to form the desired respective peripheral electrodes. In this event, the thickness in the lamination direction x can be changed by changing the groove of the gravure plate, and the shape of the peripheral electrodes of this configuration can be changed by changing the width of the groove of the gravure plate.

Furthermore, in the case of forming the printing pattern of the inner electrode layer by screen printing, a screen printing mask is designed to form the graphic pattern of the first inner electrode and then changed to the structure corresponding to the graphic pattern of the second inner electrode. This makes it possible to form the desired inner electrodes. In the case of forming the printing pattern of the peripheral electrodes by screen printing, screen printing mask is designed to form the graphic pattern of the first peripheral electrode and then changed to this structure corresponding to the graphic pattern of the second peripheral electrode. This makes it possible to form the desired respective peripheral electrodes.

A predetermined number of dielectric sheets including no inner electrode patterns or peripheral electrode patterns printed thereon are then laminated to form a portion to define a first outer layer portion 20a on the first surface 12a side. Thereafter, the portion to define the inner layer portion 18 prepared above is laminated, and the predetermined number of dielectric sheets having no inner electrode patterns or peripheral electrode patterns printed thereon are laminated on the portion to serve as the inner layer portion 18 to form a portion to serve as the second outer layer portion 20b on the second surface 12b side. A multilayer sheet is thus prepared.

Next, the multilayer sheet is pressed in the lamination direction by, for example, an isostatic press or the like to produce a multilayer block.

Then, the multilayer block is cut to a predetermined size, thus cutting out a multilayer chip. In this event, the corners and ridges of the multilayer chip may be rounded by barrel polishing or the like.

Next, the multilayer chip is fired to produce a multilayer body 12. The firing temperature depends on the ceramic and inner electrode materials, but is, for example, preferably about 900° C. or higher and about 1400° C. or lower.

Thereafter, an outer electrode 30 is formed on the multilayer body 12.

Specifically, the multilayer body 12 thus obtained is placed on a work table, and a thin film layer 32 is formed on the first surface 12a and the second surface 12b by sputtering.

Then, an underlying plating layer 34 is formed on the thin film layer 32 and the surface of the multilayer body 12, and a surface plating layer 36 is formed so as to cover the underlying plating layer 34. More specifically, for example, a Cu plating layer is formed as the underlying plating layer 34 on the thin film layer 32. Thereafter, for example, a Ni plating layer and a Sn plating layer are formed as the surface plating layer 36 on the surface of the underlying plating layer 34. Either electrolytic plating or electroless plating may be used for the plating process. However, electroless plating requires pretreatment with a catalyst or the like to improve the plating deposition speed, resulting in a disadvantage of complicating the process. Therefore, it is usually preferable to use electrolytic plating.

The multilayer ceramic capacitor 10 according to the first example embodiment illustrated in FIG. 1 can thus be manufactured. In the case of manufacturing the multilayer ceramic capacitor 10A according to the first modification illustrated in FIG. 13, the multilayer ceramic capacitor 10B according to the second modification illustrated in FIG. 14, and the multilayer ceramic capacitor 10B according to the third modification illustrated in FIG. 15, the shapes of the corresponding parts are appropriately changed in each process.

### B. Second Example Embodiment

### 1. Multilayer Ceramic Capacitor

An example of a multilayer ceramic capacitor 110 according to a second example embodiment of the present invention will be described.

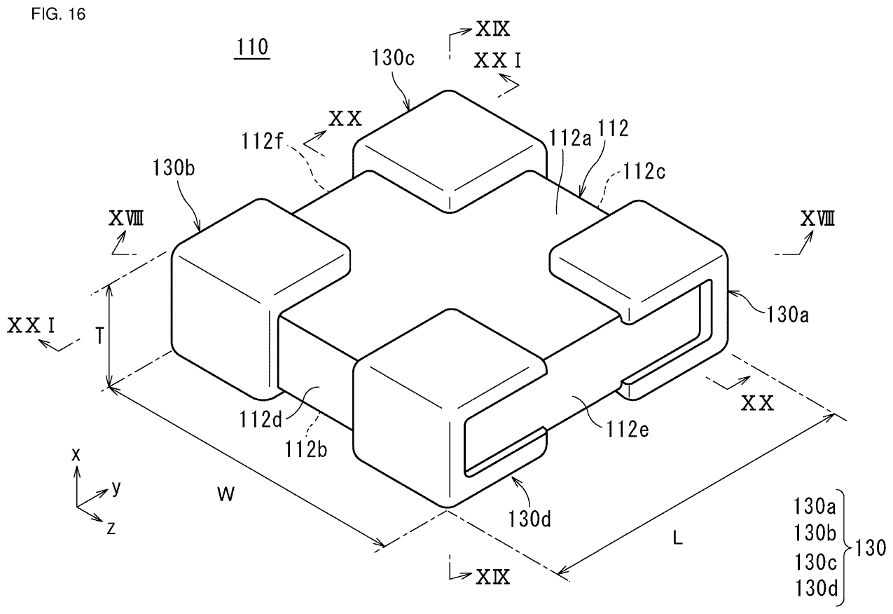

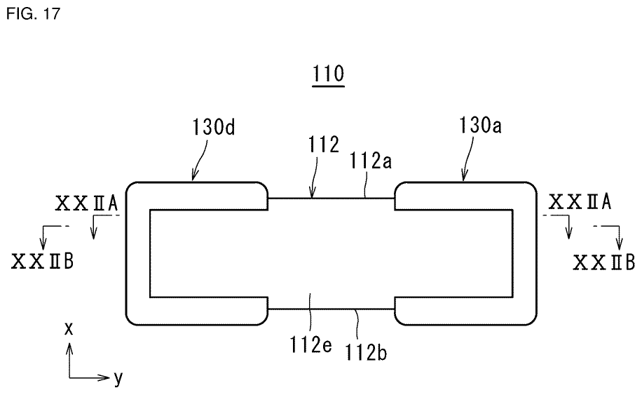

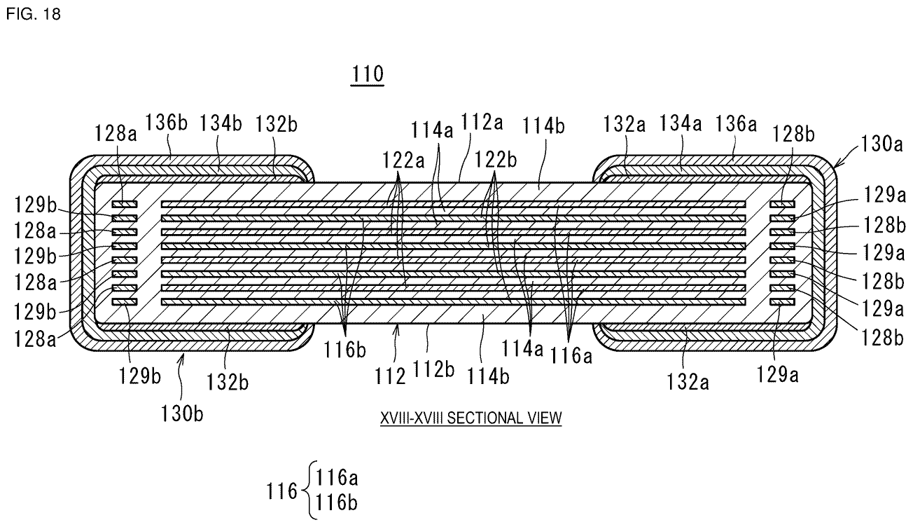

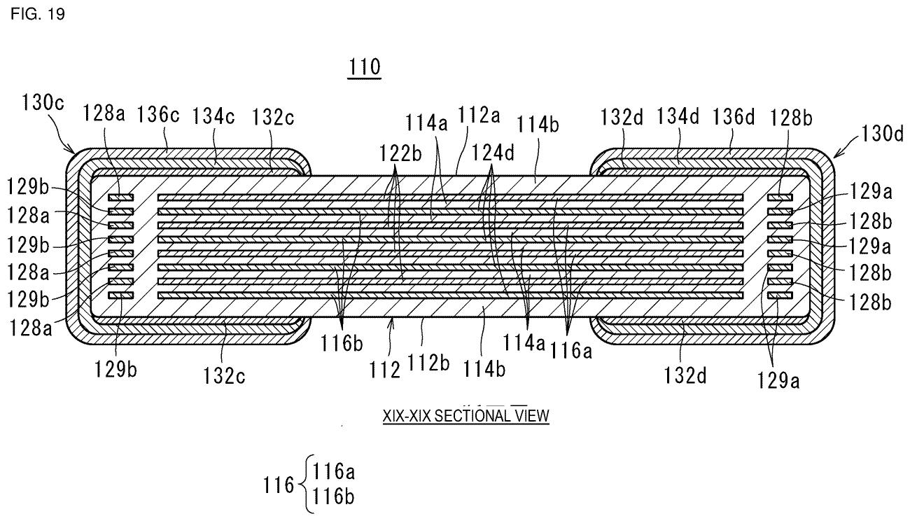

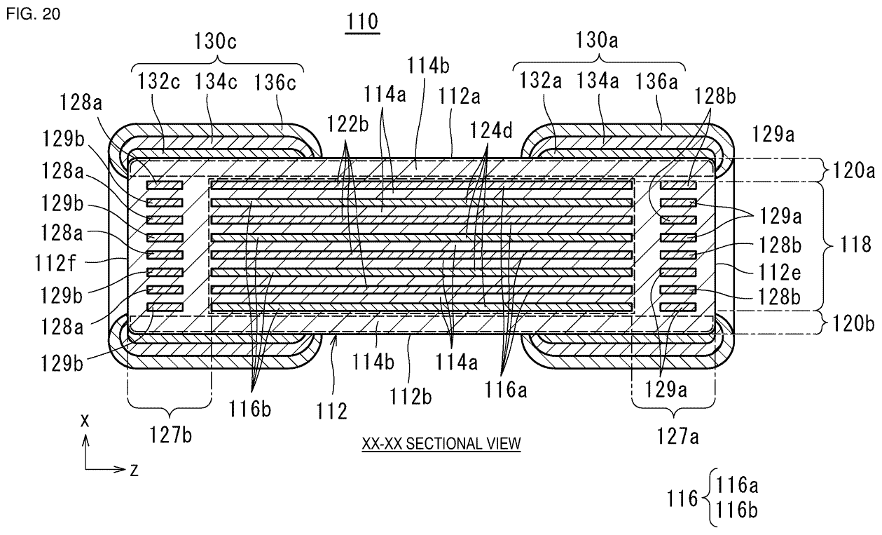

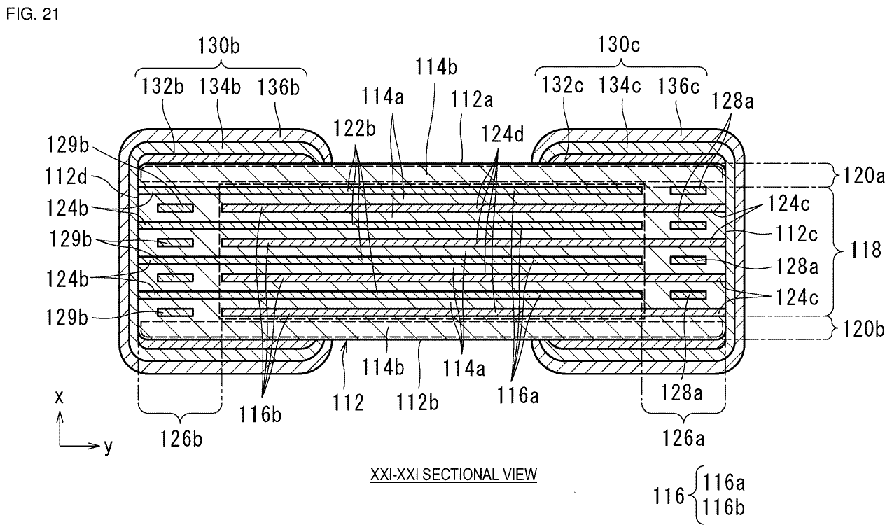

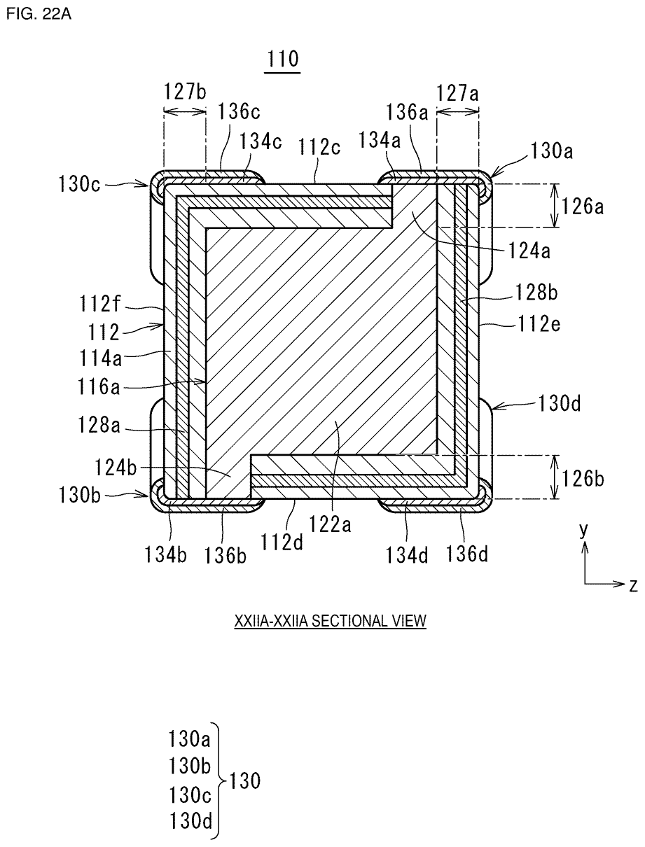

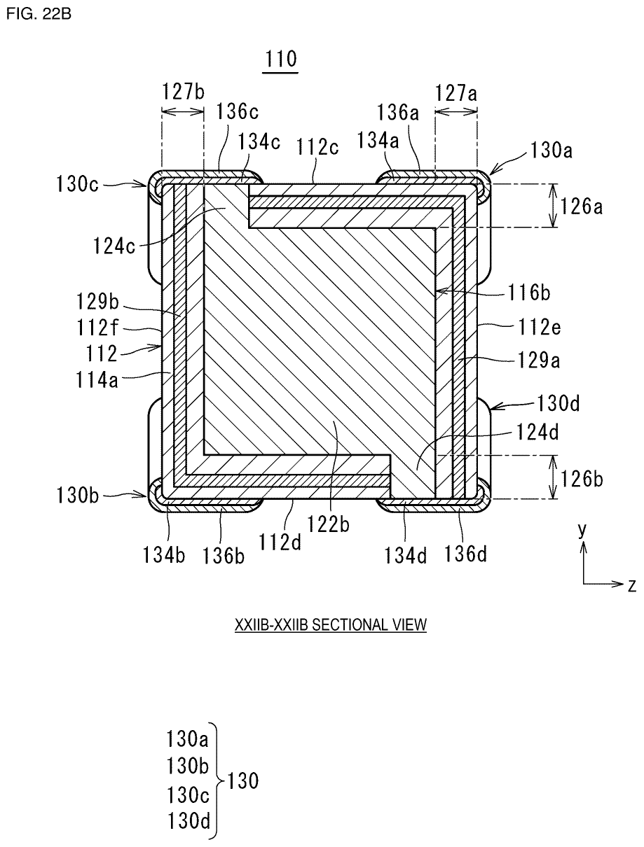

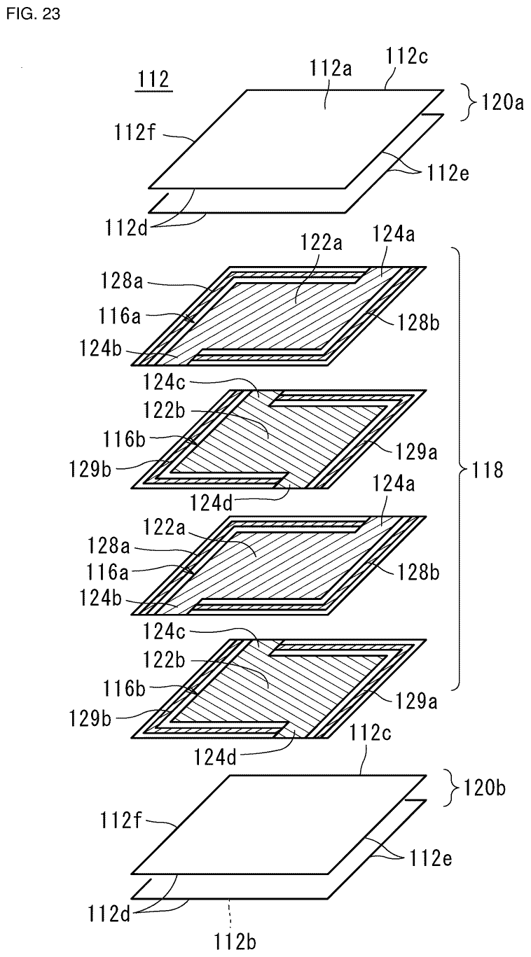

FIG. 16 is an external perspective view illustrating an example of the multilayer ceramic capacitor according to the second example embodiment of the present invention. FIG. 17 is a front view illustrating an example of the multilayer ceramic capacitor according to the second example embodiment of the present invention. FIG. 18 is a schematic sectional view taken along line XVIII-XVIII in FIG. 16 for explaining a structure of an example of the multilayer ceramic capacitor according to the second example embodiment of the present invention. FIG. 19 is a schematic sectional view taken along line XIX-XIX in FIG. 16. FIG. 20 is a schematic sectional view taken along line XX-XX in FIG. 16. FIG. 21 is a schematic sectional view taken along line XXI-XXI in FIG. 16. FIG. 22A is a schematic sectional view taken along line XXIIA-XXIIA in FIG. 17. FIG. 22B is a schematic sectional view taken along line XXIIB-XXIIB in FIG. 17. FIG. 23 is an exploded perspective view of a multilayer body illustrated in FIG. 16. Note that the same or corresponding configurations as those in FIGS. 1 to 7 will be denoted by the same reference numerals, and detailed description thereof will be omitted.

The multilayer capacitor 110 includes a multilayer body 112 and an outer electrode 130.

### Multilayer Body

The multilayer body 112 includes a plurality of dielectric layers 114 and a plurality of inner electrodes 116. The dielectric layers 114 include an inner dielectric layer 114a and an outer dielectric layer 114b. The inner electrodes 116 include a first inner electrode 116a and a second inner electrode 116b.

The multilayer body 112 also includes an inner layer portion 118, a first outer layer portion 120a located on the first surface 112a side, and a second outer layer portion 120b located on the second surface 112b side.

The first outer layer portion 120a is located on the first surface 112a side of the multilayer body 112, and is an assembly including a plurality of outer dielectric layers 114b located between the first surface 112a and the inner electrode 116 closest to the first surface 112a.

The second outer layer portion 120b is located on the second surface 112b side of the multilayer body 112, and is an assembly including a plurality of outer dielectric layers 114b located between the second surface 112b and the inner electrode 116 closest to the second surface 112b.

The inner layer portion 118 is the region sandwiched between the first outer layer portion 120a and the second outer layer portion 120b.

The inner layer portion 118 includes a first inner electrode 116a including one end exposed to a third surface 112c and another end exposed to a fourth surface 112d, a second inner electrode 116b including one end exposed to the third surface 112c and another end exposed to the fourth surface 112d, and the inner dielectric layer 114a.

Examples of the material and the like of the dielectric layer 114 are the same as those of the dielectric layer 14, and therefore description thereof will be omitted.

### Inner Electrode

The inner electrodes 116 include a plurality of first inner electrodes 116a and a plurality of second inner electrodes 116b. The first inner electrodes 116a and the second inner electrodes 116b are alternately laminated with the dielectric layers 114 interposed therebetween.

The first inner electrode 116a is disposed on the surface of the inner dielectric layer 114a. The first inner electrode 116a faces the first surface 112a and the second surface 112b, includes a first counter electrode portion 122a facing the second inner electrode 116b, and is laminated in the direction connecting the first surface 112a and the second surface 112b.

The first inner electrode 116a extends to the third surface 112c of the multilayer body 112 by a first extended electrode portion 124a, and extends to the fourth surface 112d of the multilayer body 112 by a second extended electrode portion 124b. The first extended electrode portion 124a extends to the fifth surface 112e side of the multilayer body 112. The second extended electrode portion 124b extends to the sixth surface 112f side of the multilayer body 112.

The second inner electrode 116b is disposed on a surface of an inner dielectric layer 114a different from the inner dielectric layer 114a on which the first inner electrode 116a is disposed. The second inner electrode 116b faces the first surface 112a and the second surface 112b, includes a second counter electrode portion 122b facing the first inner electrode 116a, and is laminated in the direction connecting the first surface 112a and the second surface 112b.

The second inner electrode 116b extends to the third surface 112c of the multilayer body 112 by a third extended electrode portion 124c, and extends to the fourth surface 112d of the multilayer body 112 by a fourth extended electrode portion 124d. The third extended electrode portion 124c extends to the sixth surface 112f side of the multilayer body 112. The fourth extended electrode portion 124d extends to the fifth surface 112e side of the multilayer body 112.

The first inner electrode 116a and the second inner electrode 116b are not exposed on the fifth surface 112e and the sixth surface 112f of the multilayer body 112.

When the multilayer ceramic capacitor 110 is viewed from the lamination direction x, a straight line connecting the first extended electrode portion 124a and the second extended electrode portion 124b of the first inner electrode 116a preferably intersects with a straight line connecting the third extended electrode portions 124c and the fourth extended electrode portion 124d of the second inner electrode 116b.

Furthermore, on the surfaces 112c, 112d, 112e, and 112f of the multilayer body 112, it is preferable that the first extended electrode portion 124a of the first inner electrode 116a and the fourth extended electrode portion 124d of the second inner electrode 116b extend to facing positions, and that the second extended electrode portion 124b of the first inner electrode 116a and the third extended electrode portion 124c of the second inner electrode 116b extend to facing positions.

As illustrated in FIG. 21, the multilayer body 112 includes a side portion (W gap) 126a of the multilayer body 112 located between one end in the first direction y of a second counter electrode portion 122b of the second inner electrode 116b and the third surface 112c, and a side portion (W gap) 126b of the multilayer body 112 located between the other end in the first direction y of a first counter electrode portion 122a of the first inner electrode 116a and the fourth surface 112d.

As illustrated in FIG. 20, the multilayer body 112 further includes an end portion (L gap) 127a of the multilayer body 112 located between one end in the second direction z of the second counter electrode portion 122b of the second inner electrode 116b and the fifth surface 112e, and a side portion (L gap) 127b of the multilayer body 112 located between the other end in the second direction z of the first counter electrode portion 122a of the first inner electrode 116a and the sixth surface 112f.

### Peripheral Electrode

The inner layer portion 118 of the multilayer body 112 further includes a first peripheral electrode 128 and a second peripheral electrode 129. The first peripheral electrode 128 is disposed around the first inner electrode 116a. The second peripheral electrode 129 is disposed around the second inner electrode 116b.

The first peripheral electrode 128 includes one first peripheral electrode 128a and the other first peripheral electrode 128b.

The first peripheral electrodes 128a and 128b are laminated alternately with the inner dielectric layer 114a and are disposed on the same plane as the first inner electrode 116a disposed on the inner dielectric layer 114a. As illustrated in FIG. 22A, the first peripheral electrodes 128a and 128b are each disposed at a distance from the first inner electrode 116a. The first peripheral electrode 128a is disposed in a region between the first inner electrode 116a and the third and sixth surfaces 112c and 112f. One end of the first peripheral electrode 128a is connected to the first extended electrode portion 124a of the first inner electrode 116a. Another end of the first peripheral electrode 128a is exposed on the fourth surface 112d. This makes it possible to increase the adhesion area between the first peripheral electrode 128a and the metal component in the outer electrode 130. The other end of the first peripheral electrode 128a does not have to be exposed on the fourth surface 112d.

The first peripheral electrode 128b is disposed in a region between the first inner electrode 116a and the fourth and fifth surfaces 112d and 112e. One end of the first peripheral electrode 128b is exposed on the third surface 112c. Another end of the first peripheral electrode 128a is connected to the second extended electrode portion 124b of the first inner electrode 116a. This makes it possible to increase the adhesion area between the first peripheral electrode 128b and the metal component in the outer electrode 130. One end of the first peripheral electrode 128b does not have to be exposed on the third surface 112c.

The second peripheral electrode 129 includes one second peripheral electrode 129a and the other second peripheral electrode 129b.

The second peripheral electrodes 129a and 129b are laminated alternately with the dielectric layer 114 and are disposed on the same plane as the second inner electrode 116b disposed on the dielectric layer 114. As illustrated in FIG. 22B, the second peripheral electrodes 129a and 129b are each disposed at a distance from the second inner electrode 116b.

The second peripheral electrode 129a is disposed in a region between the second inner electrode 116b and the third and fifth surfaces 12c and 12e. One end of the second peripheral electrode 129a is connected to a third extended electrode portion 24c of the second inner electrode 116b. Another end of the second peripheral electrode 29a is exposed on the fourth surface 112d. This makes it possible to increase the adhesion area between the second peripheral electrode 129a and the metal component in the outer electrode 130. The other end of the second peripheral electrode 129a does not have to be exposed on the fourth surface 112d.

The second peripheral electrode 129b is disposed in a region between the second inner electrode 116b and the fourth and sixth surfaces 112d and 112f. One end of the second peripheral electrode 129b is exposed on the third surface 112c. Another end of the second peripheral electrode 129b is connected to a fourth extended electrode portion 124d of the second inner electrode 116b. This makes it possible to increase the adhesion area between the second peripheral electrode 129b and the metal component in the outer electrode 130. One end of the second peripheral electrode 129b does not have to be exposed on the third surface 112c.

### Outer Electrode

As illustrated in FIGS. 16 to 21, the outer electrode 130 is disposed on the multilayer body 12.

The outer electrode 130 includes a plurality of outer electrodes 130 connected to the first inner electrode 116a and the second inner electrode 116b. The outer electrode 130 includes a first outer electrode 130a, a second outer electrode 130b, a third outer electrode 130c, and a fourth outer electrode 130d.

The first outer electrode 130a is disposed on the third surface 112c so as to cover the first extended electrode portion 124a of the first inner electrode 116a and also to cover a portion of the first surface 112a and a portion of the second surface 112b. The first outer electrode 130a is electrically connected to the first extended electrode portion 124a of the first inner electrode 116a.

The second outer electrode 130b is disposed on the fourth surface 112d so as to cover the second extended electrode portion 124b of the first inner electrode 116a and also to cover a portion of the first surface 112a and a portion of the second surface 112b. The second outer electrode 130b is electrically connected to the second extended electrode portion 124b of the first inner electrode 116a.

The third outer electrode 130c is disposed on the third surface 112c so as to cover the third extended electrode portion 124c of the second inner electrode 116b and also to cover a portion of the first surface 112a and a portion of the second surface 112b.

The third outer electrode 130c is electrically connected to the third extended electrode portion 124c of the second inner electrode 116b.

The fourth outer electrode 130d is disposed on the fourth surface 112d so as to cover the fourth extended electrode portion 124d of the second inner electrode 116b and also to cover a portion of the first surface 112a and a portion of the second surface 112b. The fourth outer electrode 130d is electrically connected to the fourth extended electrode portion 124d of the second inner electrode 116b.

Furthermore, as illustrated in FIG. 16, the outer electrode 130 disposed on the fifth surface 112e or the sixth surface 112f to which the inner electrode 116 is not extended preferably covers, in a U-shape, one of the short sides of the side surface to which the inner electrode 116 is not extended and portions from the end of the short side to the middle of both long sides.

In the multilayer body 112, the first counter electrode portion 122a of the first inner electrode 116a and the second counter electrode portion 122b of the second inner electrode 116b face each other across the inner dielectric layer 114a, thus generating an electrostatic capacitance. Therefore, the electrostatic capacitance can be obtained between the first outer electrode 130a and the second outer electrode 130b, to which the first inner electrode 116a is connected, and the third outer electrode 130c and the fourth outer electrode 130d, to which the second inner electrode 116b is connected, thus providing the capacitor characteristics.

It is preferable that the first outer electrode 130a, the second outer electrode 130b, the third outer electrode 130c, and the fourth outer electrode 130d each include a thin film layer 132, an underlying plating layer 134, and a surface plating layer 136.

The multilayer ceramic capacitor 110 illustrated in FIG. 16 has the same or substantially the same advantageous effects as that of the multilayer ceramic capacitor 10 according to the first example embodiment.

The multilayer ceramic capacitor 110 according to the second example embodiment of the present invention may also be combined with all or a portion of the first to third modifications described above. Furthermore, the multilayer ceramic capacitor 110 according to the second example embodiment of the present invention may be combined with all or a portion of the first to third modifications of the multilayer ceramic capacitor 10 according to the first example embodiment, and with other modifications illustrated in the drawings.

### 2. Method for Manufacturing Multilayer Ceramic Capacitor

An example of a method for manufacturing a multilayer ceramic capacitor according to the second example embodiment will be described below.

First, a dielectric sheet, a conductive paste for inner electrodes, and a conductive paste for peripheral electrodes are prepared. The dielectric sheet, the conductive paste for inner electrodes, and the conductive paste for peripheral electrodes contain a binder and a solvent. Known binders and solvents can be used.

Next, predetermined patterns are printed on the dielectric sheet using the conductive paste for inner electrodes and the conductive paste for peripheral electrodes by inkjet printing, screen printing, gravure printing, or the like, for example. A dielectric sheet on which a first inner electrode pattern and a first peripheral electrode pattern are formed and a dielectric sheet on which a second inner electrode pattern and a second peripheral electrode pattern are formed are thus prepared. Thereafter, the sheet on which the patterns of the first inner electrode and the first peripheral electrode are printed and the sheet on which the patterns of the second inner electrode and the second peripheral electrode are printed are laminated to form a portion to serve as an inner layer portion 18.

When the patterns are printed using each conductive paste, the pattern using the conductive paste for inner electrodes is printed first, and then the pattern using the conductive paste for peripheral electrodes is printed.

A predetermined number of dielectric sheets including no inner electrode patterns or peripheral electrode patterns printed thereon are then laminated to form a portion to define a first outer layer portion 120a on the first surface 112a side.

Thereafter, the portion to define the inner layer portion 118 prepared above is laminated, and the predetermined number of dielectric sheets having no inner electrode patterns or peripheral electrode patterns printed thereon are laminated on the portion to define the inner layer portion 118 to form a portion to define a second outer layer portion 120b on the second surface 112b side. A multilayer sheet is thus prepared.

Next, the multilayer sheet is pressed in the lamination direction by, for example, an isostatic press or the like to produce a multilayer block.

Then, the multilayer block is cut to a predetermined size, thus cutting out a multilayer chip. In this event, the corners and ridges of the multilayer chip may be rounded by barrel polishing or the like.

Next, the multilayer chip is fired to produce a multilayer body 112. The firing temperature depends on the ceramic and inner electrode materials, but is, for example, preferably about 900° C. or higher and about 1400° C. or lower.

Then, the multilayer body 112 thus obtained is placed on a work table, and a thin film layer 132 is formed on the first surface 112a and the second surface 112b by sputtering, for example.

In this event, the first extended electrode portion 124a of the first inner electrode 116a and the third extended electrode portion 124c of the second inner electrode 116b are exposed from the third surface 112c of the multilayer body 112. Similarly, the second extended electrode portion 124b of the first inner electrode 116a and the fourth extended electrode portion 124d of the second inner electrode 116b are exposed from the fourth surface 112d of the multilayer body 112.

Thereafter, an outer electrode 130 is formed on the multilayer body 112.

Specifically, the multilayer body 112 thus obtained is placed on a work table, and a thin film layer 132 is formed on the first surface 112a and the second surface 112b by sputtering.

Then, an underlying plating layer 134 is formed on the thin film layer 132 and the surface of the multilayer body 112, and a surface plating layer 136 is formed so as to cover the underlying plating layer 134. More specifically, for example, a Cu plating layer is formed as the underlying plating layer 134 on the thin film layer 132. Thereafter, for example, a Ni plating layer and a Sn plating layer are formed as the surface plating layer 136 on the surface of the underlying plating layer 134. Either electrolytic plating or electroless plating may be used for the plating process. However, electroless plating requires pretreatment with a catalyst or the like to improve the plating deposition speed, resulting in a disadvantage of complicating the process. Therefore, it is usually preferable to use electrolytic plating.

In this event, the outer electrode 130 disposed on the side surface to which the inner electrode 116 is not extended is formed in a U-shape by the underlying plating layer 134 and the surface plating layer 136 so as to cover both short sides of the side surface to which the inner electrode 116 is not extended and portions from the end portions of both the short sides to the middle of both long sides.

The multilayer ceramic capacitor 110 as illustrated in FIG. 16 is thus manufactured.

### C. Third Example Embodiment

### 1. Multilayer Ceramic Capacitor

An example of a multilayer ceramic capacitor 210 according to a third example embodiment of the present invention will be described.

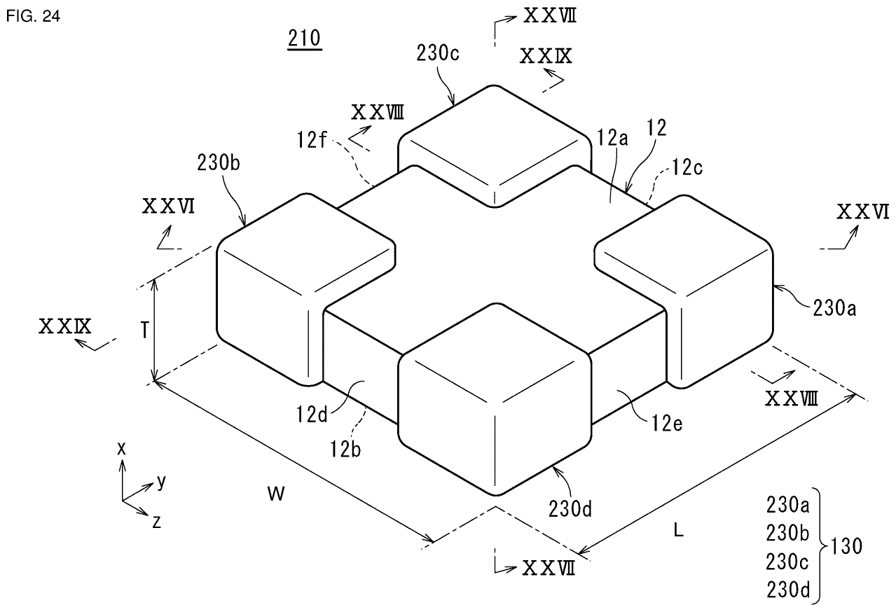

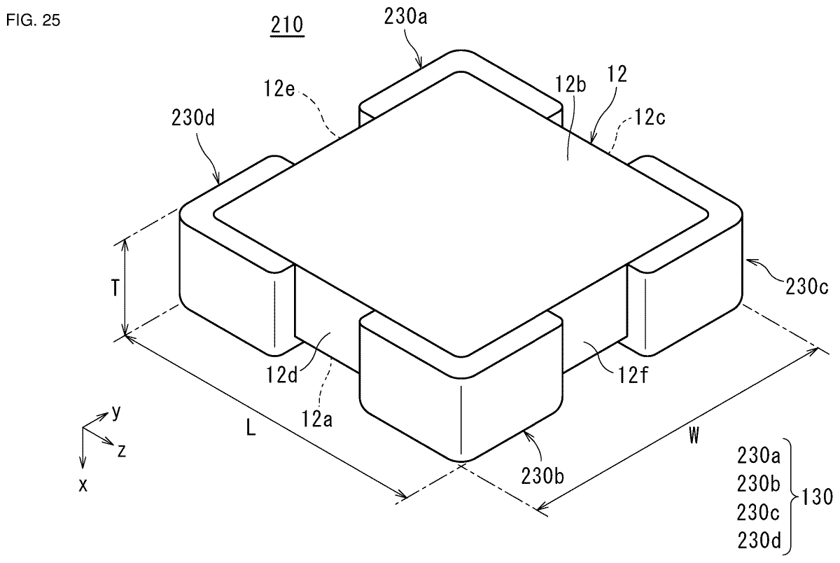

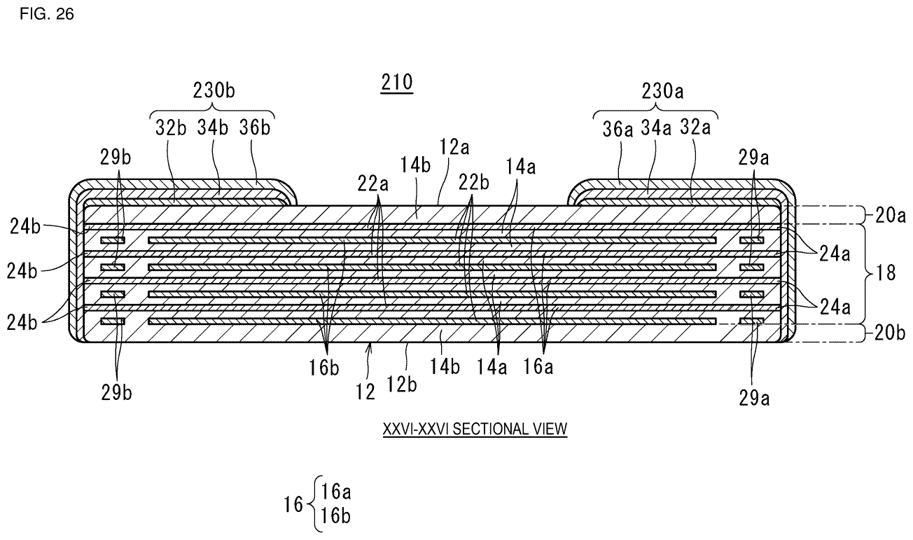

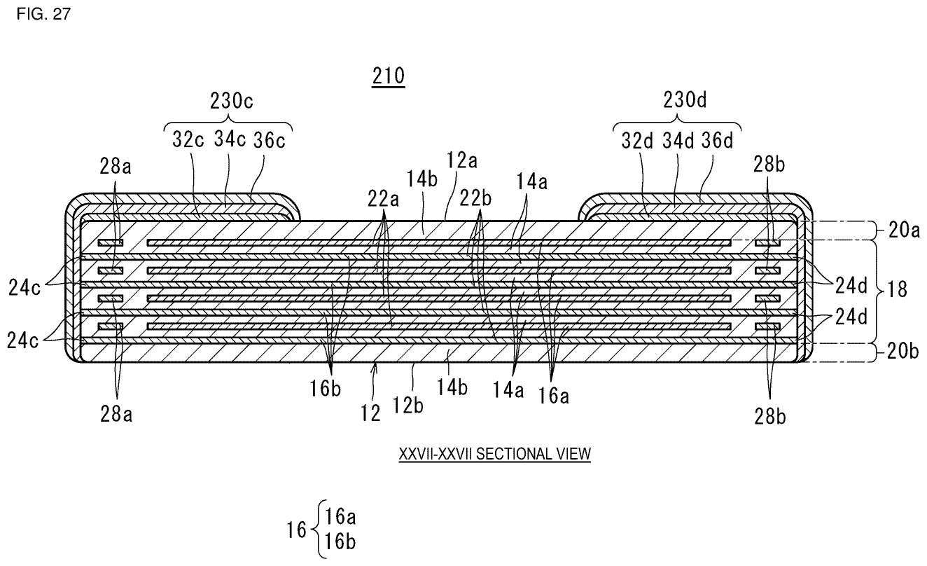

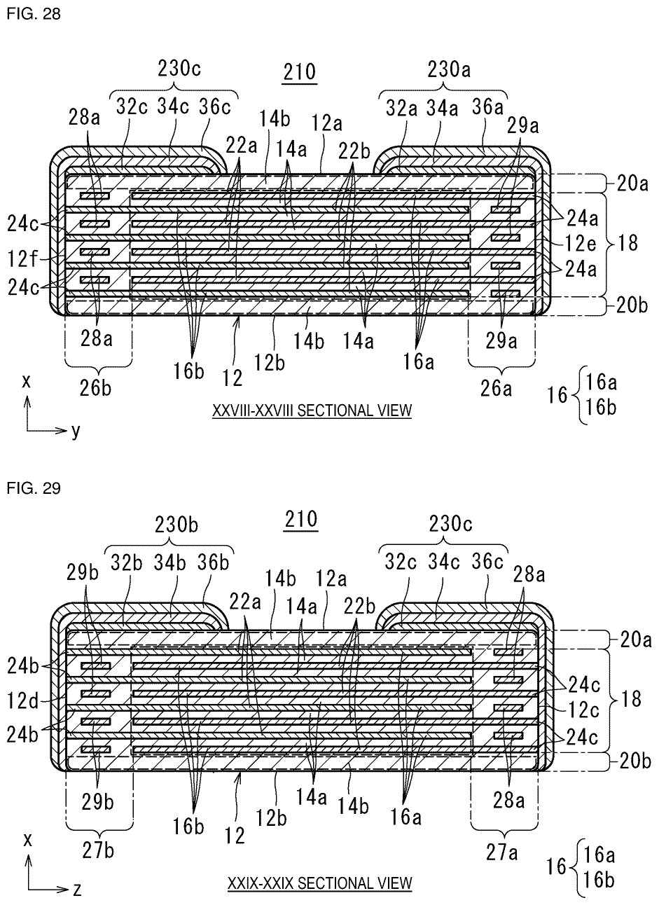

FIG. 24 is an external perspective view from one side illustrating an example of the multilayer ceramic capacitor according to the third example embodiment of the present invention. FIG. 25 is an external perspective view from the other side illustrating an example of the multilayer ceramic capacitor according to the third example embodiment of the present invention. FIG. 26 is a schematic sectional view taken along line XXVI-XXVI in FIG. 24. FIG. 27 is a schematic sectional view taken along line XXVII-XXVII in FIG. 24. FIG. 28 is a schematic sectional view taken along line XXVIII-XXVIII in FIG. 24. FIG. 29 is a schematic sectional view taken along line XXIX-XXIX in FIG. 24. Note that the same or corresponding configurations as those in FIGS. 1 to 7 will be denoted by the same reference numerals, and detailed description thereof will be omitted.

The multilayer ceramic capacitor 210 includes a multilayer body 12 and a plurality of outer electrodes 230.

### Multilayer Body

In the multilayer ceramic capacitor 210 according to the third example embodiment, the multilayer body 12 has the same or substantially the same configuration as that of the multilayer body 12 according to the first example embodiment of the present invention illustrated in FIG. 1.

### Inner Electrode

A first inner electrode 16a extends to a third surface 12c and a fifth surface 12e of the multilayer body 12 by a first extended electrode portion 24a, and extends to a fourth surface 12d and a sixth surface 12f of the multilayer body 12 by a second extended electrode portion 24b.

A second inner electrode 16b extends to the third surface 12c and a sixth surface 12f of the multilayer body 12 by a third extended electrode portion 24c, and extends to the fourth surface 12d and the fifth surface 12e of the multilayer body 12 by a fourth extended electrode portion 24d.

### Peripheral Electrode

An inner layer portion 18 of the multilayer body 12 further includes a first peripheral electrode 28 and a second peripheral electrode 29. The first peripheral electrode 28 is disposed around the first inner electrode 16a. The second peripheral electrode 29 is disposed around the second inner electrode 16b.

The first peripheral electrode 28 includes one first peripheral electrode 28a and the other first peripheral electrode 28b.

The first peripheral electrodes 28a and 28b are laminated alternately with the dielectric layer 14 and are disposed on the same plane as the first inner electrode 16a disposed on the dielectric layer 14. The first peripheral electrodes 28a and 28b are each disposed at a distance from the first inner electrode 16a.

The first peripheral electrode 28a is disposed in a region between the first inner electrode 16a and the third and sixth surfaces 12c and 12f. One end of the first peripheral electrode 28a is connected to the first extended electrode portion 24a of the first inner electrode 16a. The other end of the first peripheral electrode 28a is connected to the second extended electrode portion 24b of the first inner electrode 16a.

The first peripheral electrode 28b is disposed in a region between the first inner electrode 16a and the fourth and fifth surfaces 12d and 12e. One end of the first peripheral electrode 28b is connected to the first extended electrode portion 24a of the first inner electrode 16a. The other end of the first peripheral electrode 28a is connected to the second extended electrode portion 24b of the first inner electrode 16a.

The second peripheral electrode 29 includes one second peripheral electrode 29a and the other second peripheral electrode 29b.

The second peripheral electrodes 29a and 29b are laminated alternately with the dielectric layer 14 and are disposed on the same plane as the second inner electrode 16b disposed on the dielectric layer 14. The second peripheral electrodes 29a and 29b are each disposed at a distance from the second inner electrode 16b.

The second peripheral electrode 29a is disposed in a region between the second inner electrode 16b and the third and fifth surfaces 12c and 12e. One end of the second peripheral electrode 29a is connected to the third extended electrode portion 24c of the second inner electrode 16b. The other end of the second peripheral electrode 29a is connected to the fourth extended electrode portion 24d of the second inner electrode 16b.

The second peripheral electrode 29b is disposed in a region between the second inner electrode 16b and the fourth and sixth surfaces 12d and 12f. One end of the second peripheral electrode 29b is connected to the third extended electrode portion 24c of the second inner electrode 16b. The other end of the second peripheral electrode 29b is connected to the fourth extended electrode portion 24d of the second inner electrode 16b.

Furthermore, in the multilayer ceramic capacitor 210 according to the third example embodiment, the outer electrode 230 is disposed so as to cover the first surface 12a of the multilayer body 12 but not to cover the second surface 12b.

### Outer Electrode

As illustrated in FIGS. 24 to 29, the outer electrode 230 is disposed on the multilayer body 12.

The outer electrode 230 includes a plurality of outer electrodes 230 connected to the first inner electrode 16a and the second inner electrode 16b. The outer electrode 230 includes a first outer electrode 230a, a second outer electrode 230b, a third outer electrode 230c, and a fourth outer electrode 230d.

The first outer electrode 230a is disposed on the third surface 12c and the fifth surface 12e so as to cover the first extended electrode portion 24a of the first inner electrode 16a and also to cover a portion of the first surface 12a. The first outer electrode 230a is electrically connected to the first extended electrode portion 24a of the first inner electrode 16a.

The second outer electrode 230b is disposed on the fourth surface 12d and the sixth surface 12f so as to cover the second extended electrode portion 24b of the first inner electrode 16a and also to cover a portion of the first surface 12a. The second outer electrode 230b is electrically connected to the second extended electrode portion 24b of the first inner electrode 16a.

The third outer electrode 230c is disposed on the third surface 12c and the sixth surface 12f so as to cover the third extended electrode portion 24c of the second inner electrode 16b and also to cover a portion of the first surface 12a. The third outer electrode 230c is electrically connected to the third extended electrode portion 24c of the second inner electrode 16b.

The fourth outer electrode 230d is disposed on the fourth surface 12d and the fifth surface 12e so as to cover the fourth extended electrode portion 24d of the second inner electrode 16b and also to cover a portion of the first surface 12a. The fourth outer electrode 230d is electrically connected to the fourth extended electrode portion 24d of the second inner electrode 16b.

The multilayer ceramic capacitor 210 according to the third example embodiment illustrated in FIG. 24 has the same or substantially the same advantageous effect as those of the multilayer ceramic capacitor 10 described above, and also has the following advantageous effects.

Specifically, in the multilayer ceramic capacitor 210 according to the third example embodiment illustrated in FIG. 24, the outer electrode 130 is disposed so as to cover only the first surface 12a of the multilayer body 12 and not to cover the second surface 12b. This makes it possible to provide a multilayer ceramic capacitor with a reduced height without impairing mountability during mounting, as in the case of the multilayer ceramic capacitor 10 illustrated in FIG. 1.

The multilayer ceramic capacitor 210 according to the third example embodiment may have a configuration in which the outer electrode 230 is disposed so as to cover a portion of the second surface 12b and not to cover the first surface 12a.

The multilayer ceramic capacitor 210 according to the third example embodiment of the present invention may also be combined with all or a portion of the first to third modifications described above. Furthermore, the multilayer ceramic capacitor 210 according to the third example embodiment of the present invention may be combined with all or a portion of the first to third modifications of the multilayer ceramic capacitor 10 according to the first example embodiment, and with other modifications illustrated in the drawings.

### 2. Method for Manufacturing Multilayer Ceramic Capacitor

An example of a method for manufacturing a multilayer ceramic capacitor according to the third example embodiment will be described below.

First, a dielectric sheet, a conductive paste for inner electrodes, and a conductive paste for peripheral electrodes are prepared. The dielectric sheet, the conductive paste for inner electrodes, and the conductive paste for peripheral electrodes contain a binder and a solvent. Known binders and solvents can be used.

Next, predetermined patterns are printed on the dielectric sheet using the conductive paste for inner electrodes and the conductive paste for peripheral electrodes by inkjet printing, screen printing, gravure printing, or the like, for example. A dielectric sheet on which a first inner electrode pattern and a first peripheral electrode pattern are formed and a dielectric sheet on which a second inner electrode pattern and a second peripheral electrode pattern are formed are thus prepared.

Thereafter, the sheet on which the patterns of the first inner electrode and the first peripheral electrode are printed and the sheet on which the patterns of the second inner electrode and the second peripheral electrode are printed are laminated to form a portion to define an inner layer portion 18.

When the patterns are printed using each conductive paste, the pattern using the conductive paste for inner electrodes is printed first, and then the pattern using the conductive paste for peripheral electrodes is printed.

A predetermined number of dielectric sheets including no inner electrode patterns or peripheral electrode patterns printed thereon are then laminated to form a portion to define a first outer layer portion 20a on the first surface 12a side. Thereafter, the portion to define the inner layer portion 18 prepared above is laminated, and the predetermined number of dielectric sheets including no inner electrode patterns or peripheral electrode patterns printed thereon are laminated on the portion to define the inner layer portion 18 to form a portion to define a second outer layer portion 20b on the second surface 12b side. A multilayer sheet is thus prepared.

Next, the multilayer sheet is pressed in the lamination direction by, for example, an isostatic press or the like to produce a multilayer block.

Then, the multilayer block is cut to a predetermined size, thus cutting out a multilayer chip. In this event, the corners and ridges of the multilayer chip may be rounded by barrel polishing or the like.

Thereafter, an outer electrode 230 is formed in a multilayer body 12.

Specifically, the multilayer chip is fired to produce the multilayer body 12. The firing temperature depends on the ceramic and inner electrode materials, but is, for example preferably about 900° C. or higher and about 1400° C. or lower.

Then, the multilayer body 12 thus obtained is placed on a work table, and a thin film layer 32 is formed on the first surface 12a by sputtering.

Then, an underlying plating layer 34 is formed on the thin film layer 32 and the surface of the multilayer body 12, and a surface plating layer 36 is formed so as to cover the underlying plating layer 34. More specifically, for example, a Cu plating layer is formed as the underlying plating layer 34 on the thin film layer 32. Thereafter, for example, a Ni plating layer and a Sn plating layer are formed as the surface plating layer 36 on the surface of the underlying plating layer 34. Either electrolytic plating or electroless plating may be used for the plating process. However, electroless plating requires pretreatment with a catalyst or the like to improve the plating deposition speed, resulting in a disadvantage of complicating the process. Therefore, it is usually preferable to use electrolytic plating.

The multilayer ceramic capacitor 210 according to the third example embodiment illustrated in FIG. 24 can thus be manufactured.

The method for manufacturing the multilayer ceramic capacitor according to the present example embodiment can reduce the thickness of the T dimension in the lamination direction x of the outer electrode 230 formed on the first surface 12a. This makes it possible to provide a multilayer ceramic capacitor with a reduced height without impairing mountability during mounting.

As described above, the example embodiments of the present invention have been disclosed in the above description, but the present invention is not limited thereto.

In other words, various changes can be made to the example embodiments described above in terms of mechanism, shape, material, quantity, position, arrangement, or the like without departing from the scope of the technical idea and purpose of the present invention, and these are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction; and
four outer electrodes on the multilayer body; wherein
about 0.85≤L/W≤ about 1.00 is satisfied, where L is a dimension of the multilayer ceramic capacitor in the first direction and W is a dimension of the multilayer ceramic capacitor in the second direction;
the multilayer body includes:
a first inner electrode including one end exposed on the third surface and the fifth surface and another end exposed on the fourth surface and the sixth surface;
a second inner electrode including one end exposed on the third surface and the sixth surface and another end exposed on the fourth surface and the fifth surface; and
a peripheral electrode; and
the peripheral electrode is provided in a region between the first inner electrode and the third to sixth surfaces.

2. The multilayer ceramic capacitor according to claim 1, wherein the peripheral electrode is provided in a region between the second inner electrode and the third to sixth surfaces.

3. The multilayer ceramic capacitor according to claim 1, wherein a shortest distance between the peripheral electrode and the third to sixth surfaces is about 5.0 μm or more and about 20 μm or less.

4. The multilayer ceramic capacitor according to claim 1, wherein a width in the first direction of the peripheral electrode located between the third surface and the first inner electrode is about 1.0% or more and about 30% or less of a distance between the third surface and the first inner electrode.

5. The multilayer ceramic capacitor according to claim 3, wherein a width in the second direction of the peripheral electrode located between the fifth surface and the first inner electrode is about 1.0% or more and about 30% or less of a distance between the fifth surface and the first inner electrode.

6. The multilayer ceramic capacitor according to claim 1, wherein the peripheral electrode located between the third surface and the first inner electrode is discontinuously provided in the second direction.

7. The multilayer ceramic capacitor according to claim 6, wherein the peripheral electrode located between the fifth surface and the first inner electrode is discontinuously provided in the first direction.

8. The multilayer ceramic capacitor according to claim 6, wherein
a plurality of the peripheral electrodes are provided; and
a distance in the second direction between two of the plurality of peripheral electrodes adjacent in the second direction located between the third surface and the first inner electrode is about 1.0 μm or more and about 10 μm or less.

9. The multilayer ceramic capacitor according to claim 7, wherein
a plurality of the peripheral electrodes are provided; and
a distance in the first direction between two of the plurality of peripheral electrodes adjacent in the first direction located between the fifth surface and the first inner electrode is about 1.0 μm or more and about 10 μm or less.

10. The multilayer ceramic capacitor according to claim 1, wherein the peripheral electrode is not located on a line connecting an intersection of the third surface and the sixth surface and an intersection of the fourth surface and the fifth surface.

11. The multilayer ceramic capacitor according to claim 10, wherein the peripheral electrode is not located about 1.0 μm or more and about 10 μm or less from a corner of the first inner electrode located at a longest portion of a length of the first inner electrode in a direction connecting an intersection of the third surface and the sixth surface and an intersection of the fourth surface and the fifth surface.

12. The multilayer ceramic capacitor according to claim 1, wherein the first inner electrode includes an extended electrode portion exposed on the third surface and the fifth surface, and the extended electrode portion is not connected to the peripheral electrode.

13. The multilayer ceramic capacitor according to claim 12, wherein a distance between the extended electrode portion of the first inner electrode and the peripheral electrode is about 1.0 μm or more and about 10 μm or less.

14. A multilayer ceramic capacitor comprising:
a multilayer body including a first surface and a second surface facing each other in a lamination direction, a third surface and a fourth surface facing each other in a first direction orthogonal or substantially orthogonal to the lamination direction, and a fifth surface and a sixth surface facing each other in a second direction orthogonal or substantially orthogonal to the lamination direction and the first direction; and
four outer electrodes on the multilayer body; wherein
about 0.85≤L/W≤ about 1.00 is satisfied, where L is a dimension of the multilayer ceramic capacitor in the first direction and W is a dimension of the multilayer ceramic capacitor in the second direction;
the multilayer body includes:
a first inner electrode including one end exposed on the third surface and another end exposed on the fourth surface;
a second inner electrode including one end exposed on the third surface and another end exposed on the fourth surface; and
a peripheral electrode; and
the peripheral electrode is provided in a region between the first inner electrode and the third to sixth surfaces.

15. The multilayer ceramic capacitor according to claim 14,
wherein the peripheral electrode is located in a region between the second inner electrode and the third to sixth surfaces.

16. The multilayer ceramic capacitor according to claim 14,
wherein the peripheral electrode is exposed on the third surface and the fourth surface.

17. The multilayer ceramic capacitor according to claim 14, wherein a same type of metal component as the first inner electrode and the peripheral electrode is provided in a region between the peripheral electrode and the first inner electrode.

18. The multilayer ceramic capacitor according to claim 14, wherein
the one end of the first inner electrode is exposed on the fifth surface and the another end is exposed on the sixth surface;
the one end of the second inner electrode is exposed on the sixth surface and the another end is exposed on the fifth surface; and
a same type of metal component as the first inner electrode and the peripheral electrode is provided in a region between the peripheral electrode and the first inner electrode.

19. The multilayer ceramic capacitor according to claim 15, wherein a same type of metal component as the second inner electrode and the peripheral electrode is provided in a region between the peripheral electrode and the second inner electrode.
